(19) United States
(12) Patent Application Publication
(10) Pub. No.: US 2025/0220471 A1
(43) Pub. Date: Jul. 3, 2025

(54) NETWORK ASSISTED ERROR DETECTION FOR ARTIFICIAL INTELLIGENCE ON AIR INTERFACE

(71) Applicant: TELEFONAKTIEBOLAGET LM ERICSSON (PUBL), STOCKHOLM (SE)

(72) Inventors: Jingya Li, Göteborg (SE); Daniel Chen Larsson, Lund (SE); Adrian Garcia Rodriguez, Massy (FR); Andres Reial, Lund (SE); Icaro Leonardo Da Silva, Stockholm (SE); Henrik Rydén, Stockholm (SE)

(21) Appl. No.: 18/853,066

(22) PCT Filed: Mar. 29, 2023
(86) PCT No.: PCT/IB2023/053144

§ 371 Date: Sep. 30, 2024

Related U.S. Application Data
(60) Provisional application No. 63/324,917, filed on Mar. 29, 2022.

(51) Int. Cl. H04W 24/08; H04W 76/27

(52) U.S. Cl. CPC H04W 24/08; H04W 76/27

(57) ABSTRACT

A method performed by a user equipment (UE) for detecting performance degradation for machine learning (ML)-model performance of the UE is provided. The method comprises sending, to a network node, at least one ML-model output; and sending, to the network node, communication information, wherein the communication information is associated with communication performance of the UE. The at least one ML-model output and the communication information associated with communication performance of the UE facilitate determination of a cause of degraded performance of the UE including at least one of a cause related to the ML model or a cause unrelated to the ML model.

### CROSS REFERENCE TO RELATED APPLICATION

This application claims priority to U.S. Provisional Patent Application No. 63/324,917 filed on Mar. 29, 2022, titled “NETWORK ASSISTED ERROR DETECTION FOR ARTIFICIAL INTELLIGENCE ON AIR INTERFACE.” The content of the application is hereby incorporated by reference in its entirety for all purposes.

### FIELD

The present disclosure relates generally to communication systems and, more specifically, to methods and systems for improving machine learning (ML) model performance by detecting ML model performance degradation and analyzing causes for the degradation.

### BACKGROUND

Artificial intelligence (AI) and machine learning (ML) technologies are being developed as tools to enhance the design of air-interfaces in wireless communication networks. Example use cases of AI and ML technologies include using auto encoders for channel state information (CSI) compression to reduce the feedback overhead and improve channel prediction accuracy; using deep neural networks for classifying line of sight (LOS) and non-LOS (NLOS) conditions to enhance the positioning accuracy; using reinforcement learning for beam selection at the network node side and/or the UE side to reduce the signaling overhead and beam alignment latency; and using deep reinforcement learning to learn an optimal precoding policy for complex multiple input multiple output (MIMO) precoding problems.

In 3GPP new radio (NR) technology development, the benefits of augmenting the air-interface with features enabling improved support of AI/ML based algorithms for enhanced performance and/or reduced complexity/overhead have been, and are still being, explored. By analyzing a few selected use cases (e.g., CSI feedback, beam management and positioning, etc.), the technology development work aims at laying the foundation for future air-interface use cases leveraging AI/ML techniques.

### SUMMARY

Various computer-implemented systems, methods, and articles of manufacture for detecting ML model performance degradation and analyzing causes for the degradation are described herein.

In one embodiment, a method performed by a user equipment (UE) for detecting performance degradation for machine learning (ML)-model performance of the UE is provided. The method comprises sending, to a network node, at least one ML-model output; and sending, to the network node, communication information, wherein the communication information is associated with communication performance of the UE. The at least one ML-model output and the communication information associated with communication performance of the UE facilitate determination of a cause of degraded performance of the UE including at least one of a cause related to the ML model or a cause unrelated to the ML model.

In one embodiment, a method performed by a network node for detecting performance degradation for machine learning (ML)-model performance of a user equipment (UE) is provided. The method comprises receiving, from the UE, at least one ML-model output; receiving, from the UE, communication information associated with communication performance of the UE; and sending, to the UE, degradation information associated with a cause of degraded performance of the UE. The cause of the degraded performance of the UE includes at least one of a cause related to the ML-model or a cause unrelated to the ML model. The degradation information is determined based on the at least one ML-model output and the communication information associated with communication performance of the UE.

In one embodiment, a network node for performing user equipment (UE) machine-learning (ML) model analysis is provided. The network node comprises a transceiver, a processor, and a memory, said memory containing instructions executable by the processor whereby the network node is operative to perform receiving, from the UE, at least one ML-model output; receiving, from the UE, communication information associated with communication performance of the UE; and sending, to the UE, degradation information associated with a cause of degraded performance of the UE. The cause of the degraded performance of the UE includes at least one of a cause related to the ML-model or a cause unrelated to the ML model. The degradation information is determined based on the at least one ML-model output and the communication information associated with communication performance of the UE.

In one embodiment, a user equipment (UE) for performing user equipment (UE) machine-learning (ML) model analysis is provided. The UE comprises a transceiver, a processor, and a memory, said memory containing instructions executable by the processor whereby the UE is operative to perform sending, to a network node, at least one ML-model output; and sending, to the network node, communication information, wherein the communication information is associated with communication performance of the UE. The at least one ML-model output and the communication information associated with communication performance of the UE facilitate determination of a cause of degraded performance of the UE including at least one of a cause related to the ML model or a cause unrelated to the ML model.

Embodiments of a UE, a network node, and a wireless communication system are also provided according to the above method embodiments.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates exemplary ML model training and inference pipelines and their interactions within an ML model lifecycle management procedure, in accordance with some embodiments.

FIG. 2 illustrates an example of a communication system in accordance with some embodiments.

FIG. 3 illustrates an exemplary user equipment in accordance with some embodiments.

FIG. 4 illustrates an exemplary network node in accordance with some embodiments.

FIG. 5 is a block diagram of an exemplary host, which may be an embodiment of the host of FIG. 2, in accordance with various aspects described herein.

FIG. 6 is a block diagram illustrating an exemplary virtualization environment in which functions implemented by some embodiments may be virtualized.

FIG. 7 illustrates a communication diagram of an exemplary host communicating via a network node with a UE over a partially wireless connection in accordance with some embodiments.

FIG. 8 illustrates an example communication diagram in which the UE reports one or more parameters to assist the network node to perform the ML-model performance monitoring, in accordance with some embodiments.

FIG. 9 illustrates a signal sequence diagram among a network node, a UE, and a second network node in accordance with some embodiments.

FIG. 10 illustrates examples where the UE sends the reports including at least one ML-model output and reports including assistance information for ML-model performance monitoring in accordance with some embodiments.

FIG. 11 illustrates a signal sequence diagram among a network node, a UE, and a second network node after the network node sends the UE performance degradation information including the cause of degraded performance of the UE in accordance with some embodiments.

FIG. 12 is a flowchart illustrating a method performed by a UE in accordance with some embodiments.

FIG. 13 is a flowchart illustrating a method performed by a network node in accordance with some embodiments.

### DETAILED DESCRIPTION

To provide a more thorough understanding of the present disclosure, the following description sets forth numerous specific details, such as specific configurations, parameters, examples, and the like. It should be recognized, however, that such description is not intended as a limitation on the scope of the present disclosure but is intended to provide a better description of the exemplary embodiments.

Throughout the specification and claims, the following terms take the meanings explicitly associated herein, unless the context clearly dictates otherwise:

The phrase “in one embodiment” as used herein does not necessarily refer to the same embodiment, though it may. Thus, as described below, various embodiments of the invention may be readily combined, without departing from the scope or spirit of the invention.

As used herein, the term “or” is an inclusive “or” operator and is equivalent to the term “and/or,” unless the context clearly dictates otherwise.

The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices.

In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As described above, AI/ML techniques are being developed to enhance the design of air-interfaces in wireless communication networks. When applying AI/ML techniques to air-interference use cases, different categories of collaboration between network nodes and UEs can be considered. In a first category, there is no collaboration between network nodes and UEs. In this case, a proprietary ML model operating with an existing standard air-interface is applied at one side of the communication network (e.g., at the UE side). And the ML model's life cycle management (e.g., model selection/training, model monitoring, model retraining, and model update) is performed at this one side (e.g., at the UE side) without assistance from other sides of the network (e.g., without assistance information provided by the network node). In a second category, there is limited collaboration between network nodes and UEs. In this case, an ML model is operating at one side of the communication network (e.g., at the UE side). This side that operates the ML model receives assistance from the other side(s) of the communication network (e.g., receives assistance information provided by a network node such as a gNB) for its ML model life cycle management (e.g., for training/retraining the AI model, model update, etc.). In a third category, there is a joint ML operation between different sides of the network (e.g., between network nodes and UEs). In this case, an ML model can be split with one part located at the network node side and the other part located at the UE side. Hence, the ML model may require joint training between the network node and the UE. In this third level, the ML model life cycle management involves both sides of a communication network (e.g., both the UE and the network node).

In the present disclosure, the second category (i.e., limited collaboration between network nodes and UEs) are used for illustration and discussion. In one embodiment, an ML model operating with the existing standard air-interface is placed at the UE side. The inference output of this ML model is reported from the UE to the network node. The inference output is sometimes also referred to as the predicted output, which is generated by a trained ML model based on certain input data. Based on this inference output, the network node performs one or more operations that can affect the current and/or subsequent wireless communications between the network node and the UE.

As an example, an ML-model based UCI (Uplink Control Information) report algorithm is deployed at a UE. The UCI may comprise HARQ-ACK (Hybrid Automatic Repeat Request-Acknowledgement), SR (Scheduling Request), and/or CSI. A UE uses the ML model to estimate the UCI and reports the estimation to its serving network node such as a gNB. Based on the received CQI (Channel Quality Information) report, the network node performs one or more operations such as link-adaptation, beam selection, or/and scheduling decisions for the next data transmission to, or reception from, this UE.

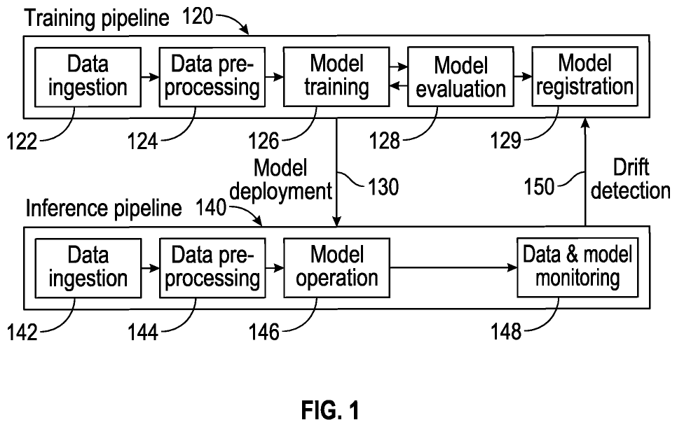

Building an ML model includes several development steps where the actual training of the ML model is one step in a training pipeline. Developing an ML model also involves the ML model's lifecycle management. This is illustrated in Error! Reference source not found.1, which illustrates exemplary ML model training and inference pipelines, and their interactions within a model lifecycle management procedure. As illustrated in FIG. 1, an ML model lifecycle management typically comprises a training (re-training) pipeline 720, a model deployment stage 730, an inference pipeline 740, and a drift detection stage 750.

In some embodiments, training (re-training) pipeline 120 includes several steps such as a data ingestion step 122, a data pre-processing step 124, a model training step 126, a model evaluation step 128, and a model registration step 129. In the data ingestion step 122, a device operating an ML model (e.g., a UE, a server, or a network node) gathers raw data (e.g., training data) from a data storage such as a database. Training data can be used by the ML model to learn patterns and relationships that exist within the data, so that a trained ML model can make accurate predictions of classifications on inference data (e.g., new data). Training data may include input data and corresponding output data. In some examples, after the ingestion of data to the device, there may also be an additional step that controls the validity of the gathered data. In the data pre-processing step 124, the device can apply some feature engineering to the gathered data. The feature engineering may include data normalization and possibly a data transformation required for the input data of the ML model. In the model training phase 126, the ML model can be trained based on the pre-processed data.

With reference still to FIG. 1, in the model evaluation step 128, the ML model's performance is evaluated (e.g., benchmarked with respect to certain baseline performance). The performance evaluation results can be used to make adjustments of the model training. Thus, the model training step 126 and the model evaluation step 128 can be iteratively performed until an acceptable level of performance (as previously exemplified) is achieved. Afterwards, the ML model is considered to be sufficiently trained to satisfy a performance requirement. The model registration step 129 then registers the ML model, including any corresponding AI/ML-meta data that provides information on how the AI/ML model was developed, and possibly AI/ML model evaluations performance outcomes.

FIG. 1 further illustrates that an ML model deployment stage 130, in which the trained (or re-trained) AI/ML model are deployed as a part of the inference pipeline 140. For example, the trained (or re-trained) ML model may be deployed to a UE for making inferences or predictions based on certain collected data. In one embodiment. the inference pipeline 140 includes a data ingestion step 142, a data pre-processing step 144, a model operation step 146, and data and model monitoring step 148. In the data ingestion step 142, a device operating an ML model (e.g., a UE, a server, or a network node) gathers raw data (e.g., inference data) from a data storage. Unlike training data, raw data or inference data can be new data that have not been encountered or used by the ML model. A trained ML model can make predictions or classifications based on the raw data or inference data.

The data pre-processing step 144 is typically identical to corresponding data pre-processing step 124 that occurs in the training pipeline 120. In the model operation step 146, the ML model uses the trained and deployed model in an operational mode such that it makes predictions or classifications from the pre-processed inference data (and/or any features obtained based on the raw inference data). In the data and model monitoring step 148, the device can validate that the inference data are from a distribution that aligns well with the training data, as well as monitor the ML model outputs for detecting any performance drifts or operational drifts. At the drift detection stage 150, the device can provide information about any drifts in the model operations. For instance, the device can provide such information to a device implementing the training pipeline 120 such that the ML model can be retrained to at least partially correcting the performance drifts or operational drifts.

In some examples, an ML model is deployed and managed at the UE side (e.g. when the UE is running the ML-model and/or when the UE is performing predictions of one or more parameters). The ML model output is a layer 1 signal that is reported by the UE to the network node via an air-interface (e.g., reporting the prediction of the received signal quality of a reference signal). The ML model output may be used by the network node for making decisions (e.g., scheduling, mobility, etc.). Under these circumstances, there can be several different error causes that may result in a system performance degradation, including, for example, a low throughput, beam failure detection, and/or radio link problems (e.g., an out-of-sync indication at the UE) possibly leading to radio link failures.

The error that may cause these performance degradations may be categorized as a first type of error causes (also referred to as error cause 1) and a second type of error causes (also referred to as error cause 2). In particular, the first type of error causes occurs when the trained ML model deployed at the UE does not generalize to certain scenarios. Thus, the ML model outputs (e.g., the estimated UCI) are incorrect; and/or the ML model produce a prediction which has a non-negligible error or low accuracy. On the other hand, the second type of error causes occurs when the trained ML model is functioning properly at the UE, but the UE or the network node still detects radio failures or performance degradation. For example, the ML model outputs (e.g., the estimated UCI) are correct, but they are received incorrectly by the network node (e.g., the gNB). That is, in this scenario, the error is introduced when transmitting the ML model output from the UE to the network node over the wireless channel and/or the air interface. As another example, the ML model output is correct, but the UE still experiences beam failures, frequent beam switches, and/or connection drops. This scenario can happen when a UE moves into a bad coverage area, or there is a sudden increase of interference present in the network to the UE transmission/reception.

The second type of error causes may more likely occur if the ML report is sent without CRC (Cyclic Redundancy Check) protection. In one example, a type of the uplink control information (UCI) is the output of the UE ML-model, and the UCI can be sent either on PUCCH (Physical Uplink Control Channel) or PUSCH (Physical Uplink Shared Channel). UCI can comprise HARQ-ACK, CSI, and SR. The payload bits in the UCI (e.g., less than 2 bits for HARQ-ACK and/or SR) can be small or large. There are cases where small payload UCI is delivered by transmitting different sequences/codes using PUCCH. Thus, in these cases, there is no CRC. When UCI is carried on PUSCH and multiplexed with data, there are also beta-factors that are used to control the MCS (Modulation and Coding Scheme) offset between data and UCI, which can impact the decoding performance of the UCI carried on PUSCH. If the UE ML-model report is a random-access preamble, then there is also no CRC protection for this. Without CRC protection, the second type of error causes may likely occur. Both the first and the second types of error causes may also cause performance degradations at the UE side. Therefore, identifying the true error cause and thereby taking the right actions at the UE or the network node can be a nontrivial problem and technically challenging. There is a need for a method to identify the different types of error causes and separately take actions to at least partially correct or prevent the performance degradations based on the identified error causes.

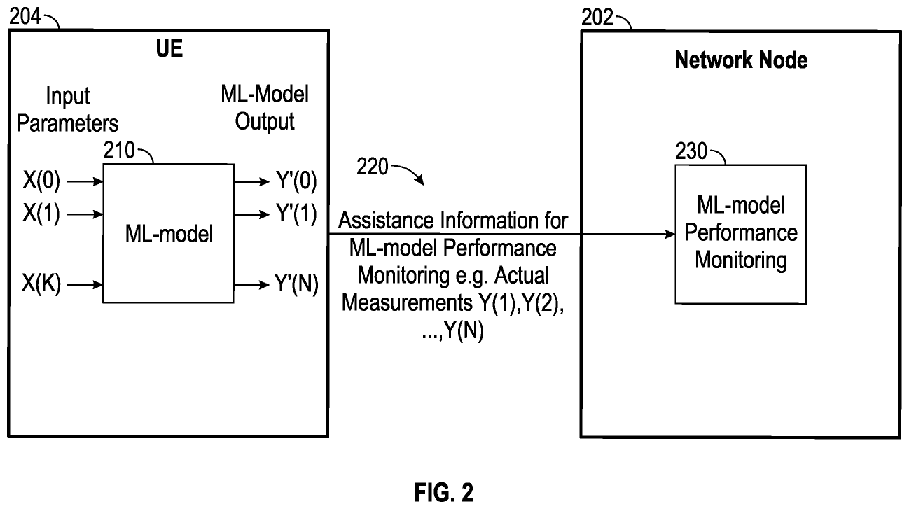

Various aspects of the present disclosure and their embodiments are described in greater details below. Embodiments of the present disclosure may provide solutions to the aforementioned and/or other challenges related to identifying an error cause of the performance degradation of the UE. Some error cause may be related to the ML model, while some may not. In one embodiment, as shown in FIG. 2, a UE 204 is deployed with at least one ML-model 210. ML model 210 is operable by UE 204. UE 204 can send assistance information 220 to network node 202, reporting one or more parameters to assist the network node 202 to perform the ML-model performance monitoring 230 (e.g., detection of errors in the ML-model performance). The one or more parameters may correspond to parameters of the same type as the ones provided as the prediction output of the ML-model 210. For example, if the ML-model output comprises one or more predictions of RSRP per beam (denoted as Y′(0), Y′(1), . . . , Y′(N)), the one or more parameters in the assistance information 220 may correspond to actual measurements of RSRP per beam (denoted as Y(0), Y(1), . . . , Y(M)). In some embodiments, the one or more parameters may also correspond to parameters of different types as the ones provided as the prediction output of the ML-model 210. For example, if the ML-model output comprises one or more predictions of RSRP per beam, the one or more parameters in the assistance information 220 may correspond to other measurements of the same or different set of beams or other types of reference signals transmitted from the UE 204. In the following description, different embodiments describe various schemes for configuring the reporting of the assistance information 220 and/or further reconfigurations to the UE 204 when the network node 202 detects a problem in the ML-model performance. The assistant information described above is an example of communication information sent from a UE (e.g., node 204) to a network node (e.g., node 202), which together with the ML model output, can facilitate determination of a cause of degraded performance of the UE including at least one of a cause related to the ML model or a cause not related to the ML model.

One of the proposed solutions described herein enables a network node (e.g., node 202) to first infer ML model performance and then communicate such information or instructions to the UE (e.g., UE 204) for at least partially correcting, resolving, or preventing the performance degradation problem. The UE may utilize the network-provided inputs to, e.g., trigger model retraining by itself or by a second node. As illustrated by the above examples, a network node may use information communicated from different UE reporting configurations and/or historical data of the UE to identify an error cause, which may be introduced when transmitting the ML model output from the UE to the network node over the wireless channel. The error cause may also be related to the ML model or not. Detail descriptions of examples of a UE, a network node, a communication system, a host, a virtualization environment, and OTT configurations are described in greater details below. One of more of these devices or configurations can be used to implement the methods and systems of the proposed solutions that enable resolving the performance degradation of a UE.

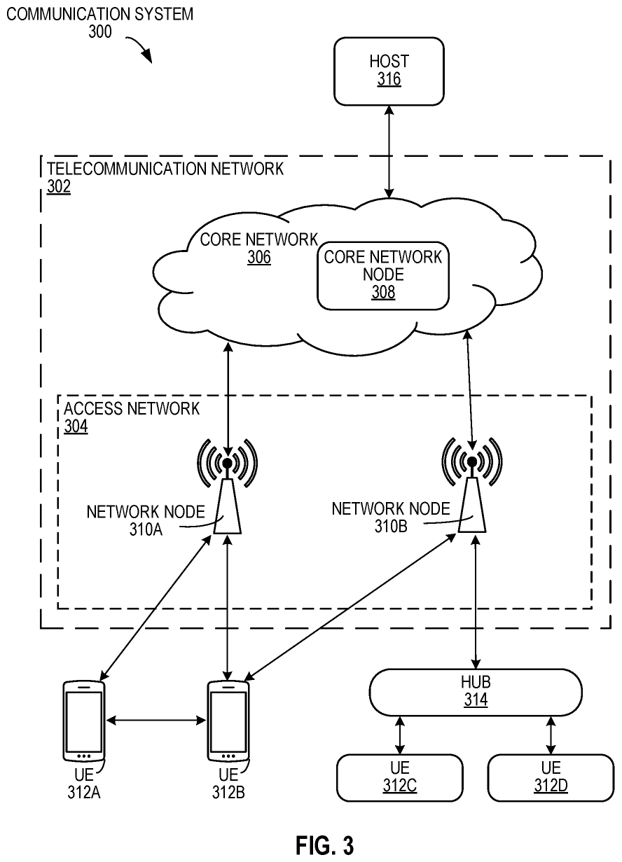

FIG. 3 shows an example of a communication system 300 in accordance with some embodiments.

In the example, the communication system 300 includes a telecommunication network 302 that includes an access network 304, such as a radio access network (RAN), and a core network 306, which includes one or more core network nodes 308. The access network 304 includes one or more access network nodes, such as network nodes 310a and 310b (one or more of which may be generally referred to as network nodes 310), or any other similar 3^{rd} Generation Partnership Project (3GPP) access node or non-3GPP access point. The network nodes 310 facilitate direct or indirect connection of user equipment (UE), such as by connecting UEs 312a, 312b, 312c, and 312d (one or more of which may be generally referred to as UEs 312) to the core network 306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 300 may include any number of wired or wireless networks, network nodes, UEs, and/or any other components or systems that may facilitate or participate in the communication of data and/or signals whether via wired or wireless connections. The communication system 300 may include and/or interface with any type of communication, telecommunication, data, cellular, radio network, and/or other similar type of system.

The UEs 312 may be any of a wide variety of communication devices, including wireless devices arranged, configured, and/or operable to communicate wirelessly with the network nodes 310 and other communication devices. Similarly, the network nodes 310 are arranged, capable, configured, and/or operable to communicate directly or indirectly with the UEs 312 and/or with other network nodes or equipment in the telecommunication network 302 to enable and/or provide network access, such as wireless network access, and/or to perform other functions, such as administration in the telecommunication network 302.

In the depicted example, the core network 306 connects the network nodes 310 to one or more hosts, such as host 316. These connections may be direct or indirect via one or more intermediary networks or devices. In other examples, network nodes may be directly coupled to hosts. The core network 306 includes one more core network nodes (e.g., core network node 308) that are structured with hardware and software components. Features of these components may be substantially similar to those described with respect to the UEs, network nodes, and/or hosts, such that the descriptions thereof are generally applicable to the corresponding components of the core network node 308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 316 may be under the ownership or control of a service provider other than an operator or provider of the access network 304 and/or the telecommunication network 302, and may be operated by the service provider or on behalf of the service provider. The host 316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 300 of FIG. 3 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 302 is a cellular network that implements 3GPP standardized features. Accordingly, the telecommunications network 302 may support network slicing to provide different logical networks to different devices that are connected to the telecommunication network 302. For example, the telecommunications network 302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 312 are configured to transmit and/or receive information without direct human interaction. For instance, a UE may be designed to transmit information to the access network 304 on a predetermined schedule, when triggered by an internal or external event, or in response to requests from the access network 304. Additionally, a UE may be configured for operating in single-or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio—Dual Connectivity (EN-DC).

In the example, the hub 314 communicates with the access network 304 to facilitate indirect communication between one or more UEs (e.g., UE 312c and/or 312d) and network nodes (e.g., network node 310b). In some examples, the hub 314 may be a controller, router, content source and analytics, or any of the other communication devices described herein regarding UEs. For example, the hub 314 may be a broadband router enabling access to the core network 306 for the UEs. As another example, the hub 314 may be a controller that sends commands or instructions to one or more actuators in the UEs. Commands or instructions may be received from the UEs, network nodes 310, or by executable code, script, process, or other instructions in the hub 314. As another example, the hub 314 may be a data collector that acts as temporary storage for UE data and, in some embodiments, may perform analysis or other processing of the data. As another example, the hub 314 may be a content source. For example, for a UE that is a VR headset, display, loudspeaker or other media delivery device, the hub 314 may retrieve VR assets, video, audio, or other media or data related to sensory information via a network node, which the hub 314 then provides to the UE either directly, after performing local processing, and/or after adding additional local content. In still another example, the hub 314 acts as a proxy server or orchestrator for the UEs, in particular in if one or more of the UEs are low energy IoT devices.

The hub 314 may have a constant/persistent or intermittent connection to the network node 310b. The hub 314 may also allow for a different communication scheme and/or schedule between the hub 314 and UEs (e.g., UE 312c and/or 312d), and between the hub 314 and the core network 306. In other examples, the hub 314 is connected to the core network 306 and/or one or more UEs via a wired connection. Moreover, the hub 314 may be configured to connect to an M2M service provider over the access network 304 and/or to another UE over a direct connection. In some scenarios, UEs may establish a wireless connection with the network nodes 310 while still connected via the hub 314 via a wired or wireless connection. In some embodiments, the hub 314 may be a dedicated hub—that is, a hub whose primary function is to route communications to/from the UEs from/to the network node 310b. In other embodiments, the hub 314 may be a non-dedicated hub—that is, a device which is capable of operating to route communications between the UEs and network node 310b, but which is additionally capable of operating as a communication start and/or end point for certain data channels.

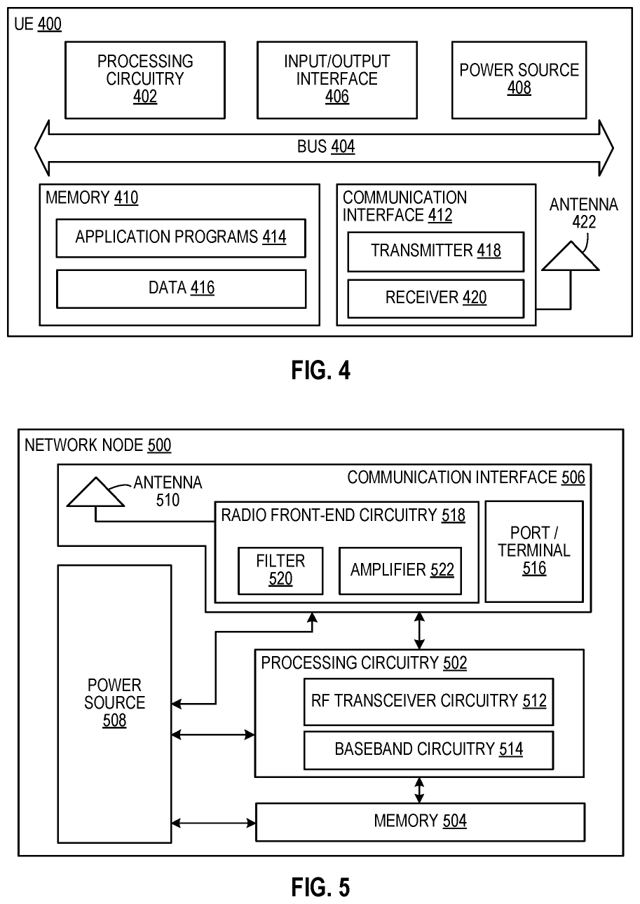

FIG. 4 shows a UE 400 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 400 includes processing circuitry 402 that is operatively coupled via a bus 404 to an input/output interface 406, a power source 408, a memory 410, a communication interface 412, and/or any other component, or any combination thereof. Certain UEs may utilize all or a subset of the components shown in FIG. 4. The level of integration between the components may vary from one UE to another UE. Further, certain UEs may contain multiple instances of a component, such as multiple processors, memories, transceivers, transmitters, receivers, etc.

The processing circuitry 402 is configured to process instructions and data and may be configured to implement any sequential state machine operative to execute instructions stored as machine-readable computer programs in the memory 410. The processing circuitry 402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 402 may include multiple central processing units (CPUs).

In the example, the input/output interface 406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 408 is structured as a battery or battery pack. Other types of power sources, such as an external power source (e.g., an electricity outlet), photovoltaic device, or power cell, may be used. The power source 408 may further include power circuitry for delivering power from the power source 408 itself, and/or an external power source, to the various parts of the UE 400 via input circuitry or an interface such as an electrical power cable. Delivering power may be, for example, for charging of the power source 408. Power circuitry may perform any formatting, converting, or other modification to the power from the power source 408 to make the power suitable for the respective components of the UE 400 to which power is supplied.

The memory 410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 410 includes one or more application programs 414, such as an operating system, web browser application, a widget, gadget engine, or other application, and corresponding data 416. The memory 410 may store, for use by the UE 400, any of a variety of various operating systems or combinations of operating systems.

The memory 410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 410 may allow the UE 400 to access instructions, application programs and the like, stored on transitory or non-transitory memory media, to off-load data, or to upload data. An article of manufacture, such as one utilizing a communication system may be tangibly embodied as or in the memory 410, which may be or comprise a device-readable storage medium.

The processing circuitry 402 may be configured to communicate with an access network or other network using the communication interface 412. The communication interface 412 may comprise one or more communication subsystems and may include or be communicatively coupled to an antenna 422. The communication interface 412 may include one or more transceivers used to communicate, such as by communicating with one or more remote transceivers of another device capable of wireless communication (e.g., another UE or a network node in an access network). Each transceiver may include a transmitter 418 and/or a receiver 420 appropriate to provide network communications (e.g., optical, electrical, frequency allocations, and so forth). Moreover, the transmitter 418 and receiver 420 may be coupled to one or more antennas (e.g., antenna 422) and may share circuit components, software or firmware, or alternatively be implemented separately.

In the illustrated embodiment, communication functions of the communication interface 412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 400 shown in FIG. 4.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 5 shows a network node 500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 500 includes a processing circuitry 502, a memory 504, a communication interface 506, and a power source 508. The network node 500 may be composed of multiple physically separate components (e.g., a NodeB component and a RNC component, or a BTS component and a BSC component, etc.), which may each have their own respective components. In certain scenarios in which the network node 500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 500 may be configured to support multiple radio access technologies (RATs). In such embodiments, some components may be duplicated (e.g., separate memory 504 for different RATs) and some components may be reused (e.g., a same antenna 510 may be shared by different RATs). The network node 500 may also include multiple sets of the various illustrated components for different wireless technologies integrated into network node 500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 500.

The processing circuitry 502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 500 components, such as the memory 504, to provide network node 500 functionality.

In some embodiments, the processing circuitry 502 includes a system on a chip (SOC). In some embodiments, the processing circuitry 502 includes one or more of radio frequency (RF) transceiver circuitry 512 and baseband processing circuitry 514. In some embodiments, the radio frequency (RF) transceiver circuitry 512 and the baseband processing circuitry 514 may be on separate chips (or sets of chips), boards, or units, such as radio units and digital units. In alternative embodiments, part or all of RF transceiver circuitry 512 and baseband processing circuitry 514 may be on the same chip or set of chips, boards, or units.

The memory 504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 502. The memory 504 may store any suitable instructions, data, or information, including a computer program, software, an application including one or more of logic, rules, code, tables, and/or other instructions capable of being executed by the processing circuitry 502 and utilized by the network node 500. The memory 504 may be used to store any calculations made by the processing circuitry 502 and/or any data received via the communication interface 506. In some embodiments, the processing circuitry 502 and memory 504 is integrated.

The communication interface 506 is used in wired or wireless communication of signaling and/or data between a network node, access network, and/or UE. As illustrated, the communication interface 506 comprises port(s)/terminal(s) 516 to send and receive data, for example to and from a network over a wired connection. The communication interface 506 also includes radio front-end circuitry 518 that may be coupled to, or in certain embodiments a part of, the antenna 510. Radio front-end circuitry 518 comprises filters 520 and amplifiers 522. The radio front-end circuitry 518 may be connected to an antenna 510 and processing circuitry 502. The radio front-end circuitry may be configured to condition signals communicated between antenna 510 and processing circuitry 502. The radio front-end circuitry 518 may receive digital data that is to be sent out to other network nodes or UEs via a wireless connection. The radio front-end circuitry 518 may convert the digital data into a radio signal having the appropriate channel and bandwidth parameters using a combination of filters 520 and/or amplifiers 522. The radio signal may then be transmitted via the antenna 510. Similarly, when receiving data, the antenna 510 may collect radio signals which are then converted into digital data by the radio front-end circuitry 518. The digital data may be passed to the processing circuitry 502. In other embodiments, the communication interface may comprise different components and/or different combinations of components.

In certain alternative embodiments, the network node 500 does not include separate radio front-end circuitry 518, instead, the processing circuitry 502 includes radio front-end circuitry and is connected to the antenna 510. Similarly, in some embodiments, all or some of the RF transceiver circuitry 512 is part of the communication interface 506. In still other embodiments, the communication interface 506 includes one or more ports or terminals 516, the radio front-end circuitry 518, and the RF transceiver circuitry 512, as part of a radio unit (not shown), and the communication interface 506 communicates with the baseband processing circuitry 514, which is part of a digital unit (not shown).

The antenna 510 may include one or more antennas, or antenna arrays, configured to send and/or receive wireless signals. The antenna 510 may be coupled to the radio front-end circuitry 518 and may be any type of antenna capable of transmitting and receiving data and/or signals wirelessly. In certain embodiments, the antenna 510 is separate from the network node 500 and connectable to the network node 500 through an interface or port.

The antenna 510, communication interface 506, and/or the processing circuitry 502 may be configured to perform any receiving operations and/or certain obtaining operations described herein as being performed by the network node. Any information, data and/or signals may be received from a UE, another network node and/or any other network equipment. Similarly, the antenna 510, the communication interface 506, and/or the processing circuitry 502 may be configured to perform any transmitting operations described herein as being performed by the network node. Any information, data and/or signals may be transmitted to a UE, another network node and/or any other network equipment.

The power source 508 provides power to the various components of network node 500 in a form suitable for the respective components (e.g., at a voltage and current level needed for each respective component). The power source 508 may further comprise, or be coupled to, power management circuitry to supply the components of the network node 500 with power for performing the functionality described herein. For example, the network node 500 may be connectable to an external power source (e.g., the power grid, an electricity outlet) via an input circuitry or interface such as an electrical cable, whereby the external power source supplies power to power circuitry of the power source 508. As a further example, the power source 508 may comprise a source of power in the form of a battery or battery pack which is connected to, or integrated in, power circuitry. The battery may provide backup power should the external power source fail.

Embodiments of the network node 500 may include additional components beyond those shown in FIG. 5 for providing certain aspects of the network node's functionality, including any of the functionality described herein and/or any functionality necessary to support the subject matter described herein. For example, the network node 500 may include user interface equipment to allow input of information into the network node 500 and to allow output of information from the network node 500. This may allow a user to perform diagnostic, maintenance, repair, and other administrative functions for the network node 500.

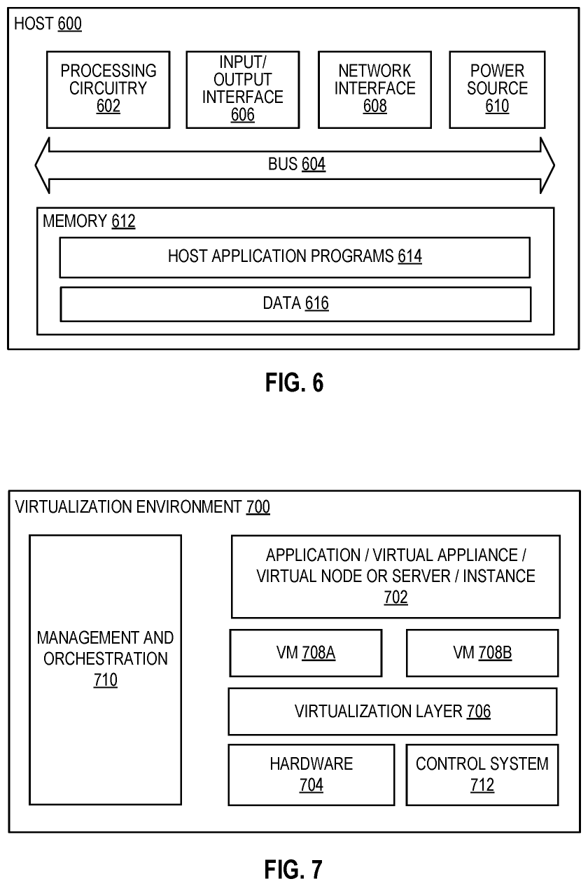

FIG. 6 is a block diagram of a host 600, which may be an embodiment of the host 316 of FIG. 3, in accordance with various aspects described herein. As used herein, the host 600 may be or comprise various combinations hardware and/or software, including a standalone server, a blade server, a cloud-implemented server, a distributed server, a virtual machine, container, or processing resources in a server farm. The host 600 may provide one or more services to one or more UEs.

The host 600 includes processing circuitry 602 that is operatively coupled via a bus 604 to an input/output interface 606, a network interface 608, a power source 610, and a memory 612. Other components may be included in other embodiments. Features of these components may be substantially similar to those described with respect to the devices of previous figures, such as FIGS. 4 and 5, such that the descriptions thereof are generally applicable to the corresponding components of host 600.

The memory 612 may include one or more computer programs including one or more host application programs 614 and data 616, which may include user data, e.g., data generated by a UE for the host 600 or data generated by the host 600 for a UE. Embodiments of the host 600 may utilize only a subset or all of the components shown. The host application programs 614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 614 may also provide for user authentication and licensing checks and may periodically report health, routes, and content availability to a central node, such as a device in or on the edge of a core network. Accordingly, the host 600 may select and/or indicate a different host for over-the-top services for a UE. The host application programs 614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 7 is a block diagram illustrating a virtualization environment 700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 702 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 706 (also referred to as hypervisors or virtual machine monitors (VMMs)), provide VMs 708a and 708b (one or more of which may be generally referred to as VMs 708), and/or perform any of the functions, features and/or benefits described in relation with some embodiments described herein. The virtualization layer 706 may present a virtual operating platform that appears like networking hardware to the VMs 708.

The VMs 708 comprise virtual processing, virtual memory, virtual networking or interface and virtual storage, and may be run by a corresponding virtualization layer 706. Different embodiments of the instance of a virtual appliance 702 may be implemented on one or more of VMs 708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 708 may be a software implementation of a physical machine that runs programs as if they were executing on a physical, non-virtualized machine. Each of the VMs 708, and that part of hardware 704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 708 on top of the hardware 704 and corresponds to the application 702.

Hardware 704 may be implemented in a standalone network node with generic or specific components. Hardware 704 may implement some functions via virtualization. Alternatively, hardware 704 may be part of a larger cluster of hardware (e.g. such as in a data center or CPE) where many hardware nodes work together and are managed via management and orchestration 710, which, among others, oversees lifecycle management of applications 702. In some embodiments, hardware 704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 712 which may alternatively be used for communication between hardware nodes and radio units.

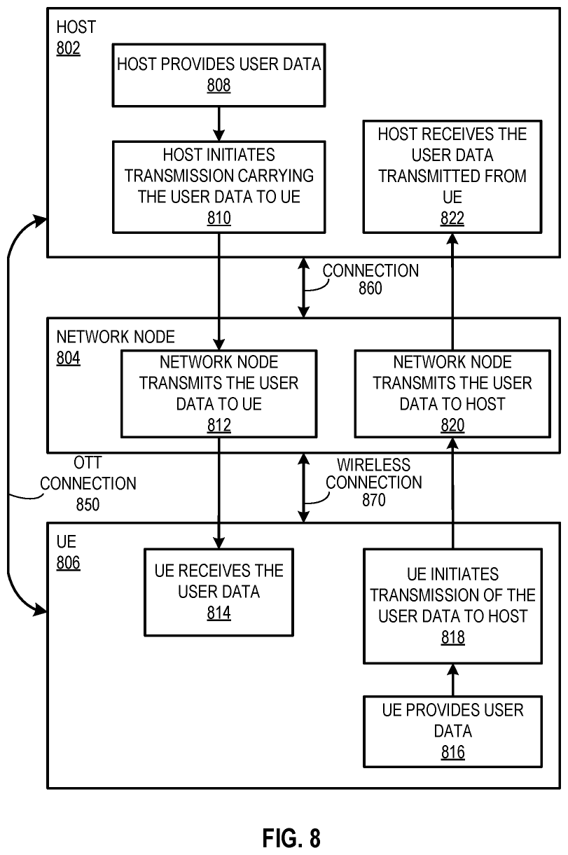

FIG. 8 shows a communication diagram of a host 802 communicating via a network node 804 with a UE 806 over a partially wireless connection in accordance with some embodiments. Example implementations, in accordance with various embodiments, of the UE (such as a UE 312a of FIG. 3 and/or UE 400 of FIG. 4), network node (such as network node 310a of FIG. 3 and/or network node 500 of FIG. 5), and host (such as host 316 of FIG. 3 and/or host 600 of FIG. 6) discussed in the preceding paragraphs will now be described with reference to FIG. 8.

Like host 600, embodiments of host 802 include hardware, such as a communication interface, processing circuitry, and memory. The host 802 also includes software, which is stored in or accessible by the host 802 and executable by the processing circuitry. The software includes a host application that may be operable to provide a service to a remote user, such as the UE 806 connecting via an over-the-top (OTT) connection 850 extending between the UE 806 and host 802. In providing the service to the remote user, a host application may provide user data which is transmitted using the OTT connection 850.

The network node 804 includes hardware enabling it to communicate with the host 802 and UE 806. The connection 860 may be direct or pass through a core network (like core network 306 of FIG. 3) and/or one or more other intermediate networks, such as one or more public, private, or hosted networks. For example, an intermediate network may be a backbone network or the Internet.

The UE 806 includes hardware and software, which is stored in or accessible by UE 806 and executable by the UE's processing circuitry. The software includes a client application, such as a web browser or operator-specific “app” that may be operable to provide a service to a human or non-human user via UE 806 with the support of the host 802. In the host 802, an executing host application may communicate with the executing client application via the OTT connection 850 terminating at the UE 806 and host 802. In providing the service to the user, the UE's client application may receive request data from the host's host application and provide user data in response to the request data. The OTT connection 850 may transfer both the request data and the user data. The UE's client application may interact with the user to generate the user data that it provides to the host application through the OTT connection 850.

The OTT connection 850 may extend via a connection 860 between the host 802 and the network node 804 and via a wireless connection 870 between the network node 804 and the UE 806 to provide the connection between the host 802 and the UE 806. The connection 860 and wireless connection 870, over which the OTT connection 850 may be provided, have been drawn abstractly to illustrate the communication between the host 802 and the UE 806 via the network node 804, without explicit reference to any intermediary devices and the precise routing of messages via these devices.

As an example of transmitting data via the OTT connection 850, in step 808, the host 802 provides user data, which may be performed by executing a host application. In some embodiments, the user data is associated with a particular human user interacting with the UE 806. In other embodiments, the user data is associated with a UE 806 that shares data with the host 802 without explicit human interaction. In step 810, the host 802 initiates a transmission carrying the user data towards the UE 806. The host 802 may initiate the transmission responsive to a request transmitted by the UE 806. The request may be caused by human interaction with the UE 806 or by operation of the client application executing on the UE 806. The transmission may pass via the network node 804, in accordance with the teachings of the embodiments described throughout this disclosure. Accordingly, in step 812, the network node 804 transmits to the UE 806 the user data that was carried in the transmission that the host 802 initiated, in accordance with the teachings of the embodiments described throughout this disclosure. In step 814, the UE 806 receives the user data carried in the transmission, which may be performed by a client application executed on the UE 806 associated with the host application executed by the host 802.

In some examples, the UE 806 executes a client application which provides user data to the host 802. The user data may be provided in reaction or response to the data received from the host 802. Accordingly, in step 816, the UE 806 may provide user data, which may be performed by executing the client application. In providing the user data, the client application may further consider user input received from the user via an input/output interface of the UE 806. Regardless of the specific manner in which the user data was provided, the UE 806 initiates, in step 818, transmission of the user data towards the host 802 via the network node 804. In step 820, in accordance with the teachings of the embodiments described throughout this disclosure, the network node 804 receives user data from the UE 806 and initiates transmission of the received user data towards the host 802. In step 822, the host 802 receives the user data carried in the transmission initiated by the UE 806.

One or more of the various embodiments improve the performance of OTT services provided to the UE 806 using the OTT connection 850, in which the wireless connection 870 forms the last segment. More precisely, the teachings of these embodiments may improve the data rate, date communication efficiencies, real-time communication capabilities, and reduce power consumption and thereby provide benefits such as reduced user waiting time, relaxed restriction on file size, improved content resolution, better responsiveness, reduced error rate or performance degradations, improved collaboration between network and UEs, and extended battery lifetime.

In an example scenario, factory status information may be collected and analyzed by the host 802. As another example, the host 802 may process audio and video data which may have been retrieved from a UE for use in creating maps. As another example, the host 802 may collect and analyze real-time data to assist in controlling vehicle congestion (e.g., controlling traffic lights). As another example, the host 802 may store surveillance video uploaded by a UE. As another example, the host 802 may store or control access to media content such as video, audio, VR or AR which it can broadcast, multicast or unicast to UEs. As other examples, the host 802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 850 between the host 802 and UE 806, in response to variations in the measurement results. The measurement procedure and/or the network functionality for reconfiguring the OTT connection may be implemented in software and hardware of the host 802 and/or UE 806. In some embodiments, sensors (not shown) may be deployed in or in association with other devices through which the OTT connection 850 passes; the sensors may participate in the measurement procedure by supplying values of the monitored quantities exemplified above, or supplying values of other physical quantities from which software may compute or estimate the monitored quantities. The reconfiguring of the OTT connection 850 may include message format, retransmission settings, preferred routing etc.; the reconfiguring need not directly alter the operation of the network node 804. Such procedures and functionalities may be known and practiced in the art. In certain embodiments, measurements may involve proprietary UE signaling that facilitates measurements of throughput, propagation times, latency and the like, by the host 802. The measurements may be implemented in that software causes messages to be transmitted, in particular empty or ‘dummy’ messages, using the OTT connection 850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

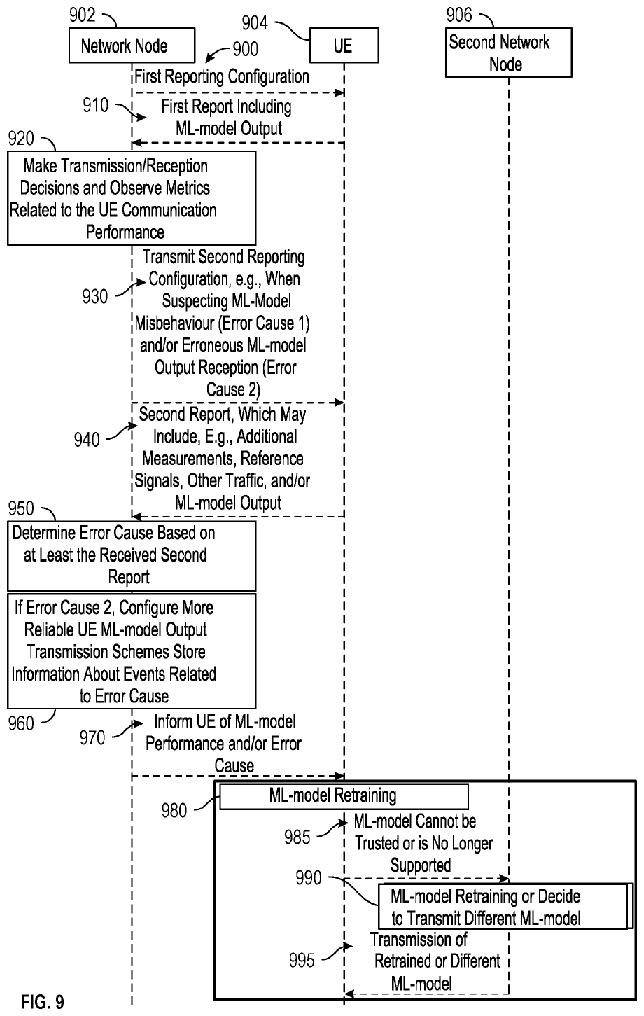

As described below in greater detail using FIGS. 9-13, the present disclosure enables a UE to provide a network node with information associated with one or more ML models operable by the UE. The proposed solution enables the network node to identify the type of an error cause, which may be introduced when transmitting the ML-model output from the UE to the network node over the wireless channel. The error cause may be related to the ML models or not. Based on the determination of the type of error causes, the network node can take proper actions to configure more reliable UE transmission schemes for the UE to report its ML-model outputs, rather than blindly asking the UE to update or retain its ML model whenever there is a performance degradation. In addition, by collecting and analyzing the information about the events that are related to the error cause, the network node can predict the future occurrence of the error cause, and thereby, triggering a more proactive way of avoiding such errors in the future. For example, the network node may send an earlier signal to the UE with a more reliable reporting configuration.

In the present disclosure, the terms “ML-model” and “AI-model” are interchangeable. For simplicity, both the ML model and the AI-model may be referred as an ML model, an AI/ML model, and/or AI/ML algorithms. An AI/ML model can be defined as a functionality or be a part of a functionality that is deployed or implemented in a first node (e.g., a UE). This first node can receive a message from a second node (e.g., a network node) indicating that the functionality is not performing correctly or that there is a performance degradation. Further, an AI/ML model can be defined as a feature or a part of a feature that is implemented or supported in a first node. This first node can indicate the feature version to a second node. If the ML-model is updated, the feature version maybe changed by the first node.

In the context of the present disclosure, at least one ML-model is deployed at the UE (e.g., proprietary) and the life cycle management of this at least one ML model is handled at least partially at the UE side. The ML model output is a layer 1 signal, which is reported to a network node via an air-interface and used directly by the network node for making transmission and/or reception decisions. The network or network node in the below description can represent, for example, a gNB, a relay node such as an IAB (Integrated Access and Backhaul) node, or any other node deployed in a network environment for direct or indirect communication with a UE. In some examples, the network node can also represent a UE performing a D2D (Device to Device) communication. The network node can further be another type of node on the network side than a gNB.

With reference back to FIG. 2, the at least one ML-model (e.g., model 210) may correspond to a function which receives one or more inputs (e.g., measurements) and provide as outcome one or more prediction(s) of a certain type. In one example, an ML-model may correspond to a function receiving inputs including the measurement of a reference signal X at time instance t0 (e.g., the reference signal X being transmitted in beam-x) and providing outputs including the prediction of the reference signal at a future time instance t0+T. In another example, an ML-model may correspond to a function receiving inputs including the measurement of a reference signal X (e.g., the reference signal X being transmitted in beam-x), such as an SSB (Synchronization Signal Block) whose index is ‘x’, and providing outputs including the prediction of other reference signals transmitted in different beams (e.g., reference signal Y transmitted in beam-y), such as an SSB whose index is ‘y’.

Another example is an ML-model for assisting CSI (Channel State Information) estimation. In such a setup, the ML-model is a specific ML-model deployed at the UE side and an ML-model deployed at the network side. Both ML-models jointly enable one or more network operations. For instance, the function of the ML-model at the UE side may include compressing a channel input; and the function of the ML-model at the network node side may include decompressing the received output from the UE. It is further possible to apply similar techniques for CSI-based positioning. In CSI-based positioning, the CSI can be used to determine the position of a wireless device such as a UE. This technique uses the changes in the channel state caused by the movement of the device to estimate its position. In CSI-based positioning, the input to an ML-model at the UE side may be a channel impulse in a certain form related to a certain reference point in time. The purpose on the network node side is to detect different peaks within the impulse response, which correspond to different reception directions of radio signals at the UE side. For positioning, another way is to provide multiple sets of measurements as inputs to an ML-model, based on which an estimated positioning can be provided. In another example, an ML-model can assist the UE in channel estimation or interference estimation for channel estimation. The channel estimation can be, for example, for the PDSCH and associated with specific set of reference signals patterns that are transmitted from the network node to the UE. The ML-model can then be part of the receiver chain within the UE and may not be directly visible within the reference signal pattern as such that is configured or scheduled to be used between the network node and UE. Another example of an ML-model for CSI estimation is to predict a suitable CQI (Channel Quality Indicator), PMI (Precoding Matrix Indicator), RI (Rank Indicator) or similar value at the future time instances. The future time instances may include a certain number of time slots after the UE has performed the last measurement or a targeted specific time slot in the future.

In at least the above-described scenarios, if there is a performance degradation at the UE side, the degradation may be related to the ML mode itself (e.g., the trained ML model at the UE cannot generalize to the current scenario to produce accurate predictions. The ML-model related error causes are referred to as the first type of error causes or error cause 1. The performance degradation may also be unrelated to the ML model. For example, the degradation may be caused by errors introduced on the ML-model output reporting over the wireless channel between the UE and the network node, but not the ML-model itself. This type of error causes are referred to as the second type of error causes or error cause 2. If the performance degradation is caused by error cause 2, then retraining and updating the ML model deployed at the UE will likely not help. And the performance degradation will not be improved or corrected. The present disclosure provides methods to enable the network node and/or the UE to detect the error that is caused during the wireless transmission of the ML-model output from the UE, and thereby taking the proper actions to improve the wireless communication performance of the UE.

FIG. 9 illustrates a signal sequence diagram among several nodes including a network node 902, a UE 904, and a second network node 906 in accordance with some embodiments. Network node 902 and second network node 906 can be implemented using any network node described above (e.g., network node 202, network node 310, network node 500, network node 804, which depict different aspects of a network node). UE 904 can be implemented using any UE described above (e.g., UE 204, UE312, UE 806, which depict different aspects of a UE). The method steps shown in FIG. 9 are described in more detail below. The concept of “network” or “network node” in the present disclosure can be understood as a generic network node, a gNB, a base station, a unit within the base station that performs at least one ML model operation, a relay node, a core network node, a core network node that performs at least one ML operation, or a device supporting device-to-device (D2D) communication. In FIG. 9, a first node is illustrated by UE 904, a second node is illustrated by network node 902, and a third node is illustrated by second network node 906. It is understood that the first, second, and third node may be different in other examples (e.g., a first node may be a network node while a second node may be a UE). The orders of the steps shown in FIG. 9 may also be altered or rearranged. The steps shown in FIG. 9 may be eliminated and/or additional steps may be added.

With reference to FIG. 9, in step 900, the network node 902 may send a first request for at least one ML-model output to the UE 904. For example, the first request may include a first reporting configuration to UE 904. In some embodiments, the first reporting configuration may be communicated to the UE 904 in a Radio Resource Control (RRC) message, a Medium Access Control (MAC)-Control Element (CE), or a layer 1 (L1) message. The layer 1 message can be, for example, in a Downlink Control Information (DCI) format. In the case the first reporting configuration is communicated in an RRC message, the RRC message may correspond to an RRC Resume message (for a UE transitioning from RRC_INACTIVE to RRC_CONNECTED), an RRC Setup message (for a UE transitioning from RRC_IDLE to RRC_CONNECTED), or an RRC Reconfiguration message (for a UE in RRC_CONNECTED). The first reporting configuration may correspond to an Information Element (IE) or a field including one or more parameters for CSI reporting and/or beam management reporting (e.g., CSI-MeasConfig). In one embodiment, the action the UE 904 performs is based on the first reporting configuration (e.g., received via RRC message) and an activation command (e.g. via MAC CE and/or DCI).

With continued reference to FIG. 9, in step 910, based on the first request such as the first reporting configuration received from network node 902, UE 904 may send a first report including the one or more ML model outputs to the network node 902. The one or more ML model outputs may include model predictions or estimates of one or more parameters in future time instances.

In step 920, the network node 902 may utilize the received first report from the UE 904 to make transmission/reception or configuration decisions and observes metrics related to the communication performance of the UE 904. In some examples, based on the first report received from the UE 904, network node 902 determines configurations for the UE 904 to send a second report with additional or alternative information. The configurations may include, for example, new CSI measurement configurations (e.g. reconfiguration of one or more parameters within a CSI-MeascConfig), one or more synchronization signal blocks (SSBs) and/or CSI-RS resources to be measured, new reporting configurations, etc. As described ablow, based on the configurations, UE 904 may send a second report including CSI reports of actual measurements. When the CSI reports of the actual measurements are received by the network node 902, it may infer the performance of the ML-model deployed to the UE 904.

With continued reference to FIG. 9, in step 930, the network node 902 sends UE 904 a request for communication information. The requested information may facilitate identifying the error causes for performance degradations. For example, based on the first report and/or the second report described below, both provided by the UE 904, network node 902 can detect performance degradations of the UE 904, and request further information from the UE 904 for assisting in identifying the error causes. The detection of performance degradations can be based on the UE 904′s previous performance, an average performance of one or more other UEs, estimated performance or estimated report contents based on UE modeling in the network node 902; an uncertainty indication signaled from the UE; and a reliability indication signaled from the UE. For instance, the network node 902 may detect performance problems, degradations, or any other deviations from the normal performances (collectively as performance degradations) in one or more of the following manners. In one example, the network node 902 determines performance degradations by comparing the UE's current performance to the same UE's previous performance based on of certain performance metrics (e.g., Block-Error Rate or BLER, Throughput or TP, estimated Signal-to-Interference-plus-Noise Ratio or SINR). The network node 902 may also determine performance degradations by comparing the UE's current performance to other UE's average performance in the same cell or cell region, or for the same or similar link quality metrics. In some examples, the detection of performance degradation may be based on a sudden change or inconsistency compared to same UE's previous reports; deviation or inconsistency compared to other UE's reports in the same cell or cell region; deviation or inconsistency compared to estimated performance or estimated report contents based on UE modeling in the network node 902; and/or high uncertainty or low reliability indication signaled from the UE. It is understood that above are example information based on which performance degradation may be detected, but other approaches are also possible.

In some examples, if network node 902 detects performance degradations at UE 904, it may send a request for further information for identifying the error causes of the performance degradation. In some examples, network node 902 sends the request regardless of whether performance degradations are detected. The request sent by network node 902 may include a second reporting configuration for the UE 904. In an embodiment, this request may be transmitted to UE 904 when the network node 902 suspects a misbehavior or performance degradation of the ML-model (e.g., error cause 1) and/or an erroneous reception of the ML-model output (e.g., error cause 2). For instance, the second reporting configuration may be transmitted when the network node 902 observes a degradation in the metrics related to communication performance of the UE 904, when the UE 904 indicates its performance degradation to the network node 902, and/or the network node 902 observes one or a series of anomalous values in the ML-model output. As described later, in some embodiments, the second reporting configuration may be transmitted together with the first reporting configuration, in a combined reporting configuration. That is, the first request including the first reporting configuration (transmitted in step 900) and the second request including the second configuration(s) (transmitted in step 930) may be combined and transmitted in one communication from network node 902 to UE 904. For instance, they may be transmitted in the same message, instructing the UE 904 to report the output of the ML-model and/or the one or more parameters for assisting the network node 902 to monitor the performance of the ML-model.

With continued reference to FIG. 9, in step 940, based on the request including, e.g., the second reporting configuration received from network node 902, the UE 904 sends the requested communication information associated with performance of the UE 904 to network node 902. The communication information sent by UE 904 may include a second report. In an embodiment, the transmission configuration of the second report from UE 904 is different from that the first report from UE 904 (in step 910), such that one or both of the first report and the second report enable the network node 902 to identify whether the performance degradation of the UE is due to the second type of error cause (i.e., error cause 2 that is unrelated to the ML model). In one example of the differences between the first report and the second report, the second report includes actual measurements of the metrics corresponding to the previous ML model predictions included in the first report. As an example, if in the first report (sent in step 910), UE 904 includes a CSI prediction for a sub-band X; then in the second report (sent in step 940), UE 904 includes the actual CSI measurement for sub-band X. As another example, if in the first report (sent in step 910), UE 904 includes one or more Beam Measurement predictions for SSB Y, then UE 904 includes the actual Beam Measurement for SSB Y in the second report (sent in step 940). In an embodiment, the network node 902 may request the UE 904 to a) report other measurements (e.g., Packet Header Ratio or PHR, Reference Signal Received Power or RSRP, Reference Signal Strength Indicator or RSSI, Reference Signal Received Quality or RSRQ, Channel State Information-Interference Matrix or CSI-IM-derived, and/or SINR values); b) transmit reference signals (e.g., Demodulation Reference Signal or DMRS, Sounding Reference Signal or SRS, Positioning Reference Signal or PRS); c) multiplex other type of traffic (e.g., PUSCH), and/or d) transmit the ML-model output (i.e., the estimated Uplink Control Information or estimated UCI).

In some embodiments, the second reporting configuration provided by network 902 in step 930 may be applied to: a future measurement and reporting occasion, e.g., a next CSI-RS measurement and the associated report, where the report comprises a future ML-based estimate and additional data pertaining to the future occasion; the current measurement and a future reporting occasion, where the report comprises a future ML-based estimate and additional data pertaining to the current occasion; and/or an additional reporting occasion, where the report contains additional data pertaining to the current occasion. In some embodiments, the network node 902 may provide the second reporting configuration periodically, non-periodically (e.g., one-shot), and/or even-triggered.

With continued reference to FIG. 9, in step 950, the network node 902 determines degradation information including the error causes of the performance degradations by utilizing at least the received second report from the UE 904. For instance, based at least on the second report received in step 940, the network node 902, in step 950, determines whether the performance degradation of the UE 904 was due to error cause 1 or error cause 2 described above. For instance, if the UE 904 is sending other type of traffic to the network node 902 at the same time of reporting the ML model output, the network node 902 can identify the error cause based on whether the other type of traffic also experiences a performance degradation. If the other type of traffic experiences a performance degradation similar to that from UE 904, then it is likely that the performance degradation of the UE 904 can be attributed to error cause 2 (i.e., a cause that is unrelated to the ML-model itself). The network node 902 can also utilize historical link performance-related data about the UE 904 to identify the error cause. This performance-related data may include data derived from, e.g., other measurements, reference signals, other type of traffic, and/or the ML-model output.

In some embodiments, the network node 902 may use the contents of the second reporting configuration to determine the error cause in multiple ways, including: comparing ML report contents in the first and second reports (e.g., the ML model output predictions and actual measurements); comparing ML report contents and additional information (measurements, etc.) provided in the second report; evaluating link conditions based on the additional information in the second report; and/or considering the UCI false detection probability, based on the CRC length for the first report payload, among others.

One or more of the above-described steps (e.g., one or more steps 900-950), including the step of differentiating the first and second types of error causes (i.e., error causes 1 and 2), can be applied to many scenarios, including when the UE reporting procedures are performed via UCI with a small payload and when the CRC protection is not present or is weak. Examples of such procedures include ML-based or ML-related signaling using non-legacy UCI formats. A non-legacy UCI format refers to a new format for UCI in 5G or beyond telecommunication technologies, which is different from the format used in previous generations of wireless communication systems, such as 4G LTE. In 5G techniques, for example, UCI can be transmitted using two different formats: the legacy format, which is backward compatible with LTE, and the non-legacy format, which is designed specifically for 5G. The non-legacy UCI format is generally more efficient and flexible than the legacy format, allowing for a wider range of control information to be transmitted in a more compact and streamlined manner. Such reporting via UCI using non-legacy UCI format may correspond to, for example, the UE status reporting to aid the network node 902′s operation, uplink (UL) bit bucket for data transfer during a split-model operation, new formats of ML-based CSI estimation and reporting, ML-based beam management reporting, or the like.

In an example, a ML-model based UCI report algorithm is deployed at a UE (e.g., UE 904). The UCI report may include HARQ-ACK, SR, and/or CSI. The UE uses this ML model to estimate the UCI and report them to its serving network node (e.g., network node 902). Based on the received UCI report, the network node performs link-adaptation, beam selection, and/or scheduling decisions for the next data transmission to, or reception from, this UE. For example, the first reporting configuration, sent from the network node to the UE, may be for the UE to report its ML-model output, e.g., the estimated UCI provided by the ML model. When detecting a performance degradation (e.g., the UE's absolute or relative throughput drop is larger than a threshold) and/or an anomalous value in the temporal series of the ML-model output, the network node may send a second reporting configuration to the UE. In addition to the ML-model output (i.e., the estimation UCI), this second reporting configuration may request the UE to include other measurements (e.g., RSRP, RSSI, RSRQ, SINR, PHR, interference based on, e.g., CSI-IMs values) and/or transmit reference signals (e.g., DMRS, SRS, PRS). The network node can use these reference signals and/or other measurements reported from this UE to estimate the UE's condition (based on, e.g., useful link strength and interference) and determine if the error has been introduced when transmitting these UCI over the wireless channel.

In one embodiment, the second reporting configuration may request the UE to multiplex some uplink data payload with the estimated UCI and transmit them over PUSCH and/or adjust the associated beta-offset values. The beta-offset are the parameters that control the MCS offset between the associated type of UCI and the data. Then, the network node can estimate the CQI decoding performance based on the data payload decoding performance, thereby checking if an error has been introduced when transmitting these UCI over the wireless channel.

In another embodiment, this second reporting configuration may request the UE to transmit the ML-model output (e.g., the estimated UCI) using a more reliable transmission method, e.g., by using repetition, lower MCS schemes, higher transmit power, etc. If the performance degradation disappears, the network node can determine that an error is likely introduced when transmitting the ML model output carried on the first report over the wireless channel.

With continued reference to FIG. 9, and as described above, steps 900 and 930 may be combined such that the UE 904 receives a combined reporting configuration, instead of two separate reporting configures. For instance, the UE 904 may be configured with a combined reporting configuration including: i) a first configuration (or first reporting configuration) for the report of the outputs of the UE 904′s ML-model (e.g., denoted by Y′ (0), . . . , Y′ (K)), and ii) a second configuration (or second reporting configuration) for the report of communication information including one or more parameters to assist the network node 902 to perform the ML-model performance monitoring (e.g. assist in detection of errors in the ML-model performance). For example, the first configuration is for the reporting of ML-model outputs including, for example, one or more predictions of RSRP per beam (denoted by Y′(0), Y′(1), . . . , Y′(N)). And the second configuration is for the reporting of the one or more parameters corresponding to actual measurements of RSRP per beam (denoted by Y(0), Y(1), . . . , Y(M)). As shown in FIG. 9, receiving the combined configurations can be equivalent to the UE 904 receiving the configurations in steps 910 and 930 in the same message, but including the first and the second reporting configurations described above. And if UE 904 receives the combined configurations, instead of step 920 being performed in between steps 910 and 930, UE 904 can report the ML-model outputs and communication information including one or more parameters for assisting the network node 902 to perform steps 920 (e.g., for detecting performance degradation), 950 (e.g., for identifying error causes), and/or 960 (e.g., for configuring more reliable UE ML-model output transmission schemes and/or for storing events related to the error cause). Step 960 is described in more details below.

In one embodiment, the first configuration includes a first time-domain configuration for the reporting of the ML-model outputs; and the second configuration includes a second time-domain configuration for the reporting of the communication information comprising one or more parameters to assist the network node 902 to monitor the performance of the ML-model deployed in UE 904. In one option, the first and second time-domain configuration(s) are different. For example, the outputs of the ML-model may be transmitted by the UE 904 more often than the one or more parameters. The more frequent-reporting of the ML-model outputs can be beneficial as the UE 904 may perform predictions by using the ML-model and obtain the model outputs more often than it performs actual measurements (e.g., performing actual measurements may possibly consume more power of the UE 904). As a result, making predictions more often than performing actual measurements can save power for UE 904. At the same time, UE 904 can still provide, in addition to the ML model outputs, assistance information to the network node 902 enabling the network node 902 to evaluate the ML-model performance and/or perform root cause analysis as to the performance degradations or failures.

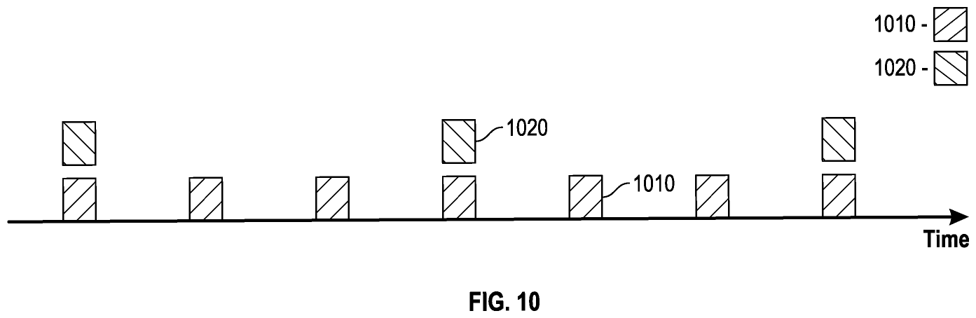

As described above, the first configuration and the second configuration, provided by network node 902, can both be time-domain configurations. In one option, the first and second time-domain configuration(s) are different, but may overlap so that one is a sub-set of the other. In that case, the communication of the second configuration from network node 902 to UE 904 may be optimized to only include the difference between the two configurations, (e.g., using the first configuration as a reference). In addition, the actual reports provided by the UE 904 may be different or of the same type with some transmission occasions including the assistance information for the network node 902, as shown in the FIG. 10.

FIG. 10 illustrates examples where a UE (e.g. UE 904) sends multiple reports including at least one ML-model output and reports including assistance information for ML-model performance monitoring in accordance with some embodiments. With reference to FIG. 10, the multiple reports may be transmitted by the UE in multiple transmission occasions at different time slots. Each block 1020 in FIG. 10 represents a UE report including the assistance information for ML-model performance monitoring. These blocks 1020 thus represent multiple instances of the second report sent by the UE. Each block 1010 in FIG. 10 represents a UE report including ML-model outputs. These blocks 1010 thus represent multiple instances of the first report sent by the UE. FIG. 10 therefore illustrates that in the same or similar time intervals, the UE may transmit the ML model outputs (instances of the first report represented by 1010) more often than the assistance information for ML-model performance monitoring (instances of the second report represented by 1020). FIG. 10 also illustrates that transmission of some of the instances of the first report (represented by 1010) and instances of the second report (represented by 1020) may be synchronized (e.g., transmitted in the same time slot or in the same message).

With reference back to FIG. 9, in one embodiment, the reporting configuration (e.g., the second reporting configuration in step 930 and/or a combined reporting configuration) includes the configuration for one or more resources of at least one Uplink control channel, such as a PUSCH) or PUCCH, e.g., as defined in TS 38.300

In one embodiment, the first and second time-domain configuration(s) are for one or more of the following reporting types: i) periodic, ii) aperiodic, iii) semi-persistent, and iv) event-triggered. The first and the second configurations may be the same or different, for example, the first configuration may be set to periodic or semi-persistent, while the second configuration may be aperiodic.

In one embodiment, the time-domain configuration includes at least one or more of: i) periodicity (a time interval or frequency in which the report is to be transmitted), ii) a slot offset from which the UE 904 derives the frame number and slot to transmit the report. This is mainly applicable for the case of a periodic report and/or semi-persistent report.

In one embodiment, the first configuration is set to periodic (or semi-persistent), while the second configuration may be aperiodic. The UE 904 periodically reports one or more ML-model outputs, but only reports the communication information upon receiving a request from the network node 902 (e.g. reception of a DCI and/or MAC CE). As described above, the communication information comprises one or more parameters for assisting the network node 902 to monitor the ML-model performance (and/or to detect ML-model failure). In some examples, the UE 904 receives the request for transmitting the communication information (or assistance information) when the network node 902 determines that it needs to evaluate the ML-model performance (which may be due to some system performance degradation). Using FIG. 9 as a reference, in some examples, the periodical reports of the ML-model outputs can be configured at the UE 904 in step 900 (e.g., when network node 902 sends a first request including the first reporting configuration to UE 904). The periodical reports provided by UE 904 can be similar to the first report transmitted in step 910, which includes ML-model outputs. The request for the one or more parameters assisting the network to perform ML-model performing monitoring can be a request similar to that transmitted in step 930, while the report of the one or more parameters assisting the network to perform ML-model performing monitoring corresponds to that transmitted in step 940.

In some embodiments, the UE 904 is configured to obtain the communication information comprising the one or more parameters for assisting the network node 902 to perform ML-model performance monitoring in an offline manner. Thus, the contents of the second report shown in step 940 can be obtained offline. UE 904 can perform measurements but not transmitted the data obtained from the measurements when the UE 904 is, for example, in RRC_IDLE or RRC_INACTIVE. In these situations, the UE 904 can obtain the one or more parameters (e.g., by performing the one or more measurements) and associate the obtained data to a certain label to be later identified by the network node 902 when they are reported. The certain label may include, for example, time-domain information (e.g., absolute time so the network node identifies when the measurement was performed), a location (e.g., a cell ID of the UE 904′s serving cell, such as the Serving Primary Cell or SpCell), a UE 904′s identifier (e.g., for identifying a UE 904 Access Stratum context), an ML-model ID, or the like. As shown in FIG. 9, these offline actions to be performed by UE 904 may be configured in step 930 and sent to UE 904 from network node 902.

In one embodiment, the UE 904 obtains the communication information comprising one or more parameters for ML-model performance monitoring by the network node 902 (e.g., by performing one or more offline measurements), while it is in RRC_IDLE or RRC_INACTIVE. Then, when the UE 904 transitions to RRC_CONNECTED, UE 904 reports these one or more parameters to the network node 902 (e.g., it transmits the report of assistance information for the ML-output performance monitoring at the network node).

In one embodiment, the UE 904 transmits an indication to the network node 902 that the one or more parameters and/or a report including the one or more parameters are available (or stored). In one option, if the UE 904 is in RRC_INACTIVE, the indication can be included in an RRC Resume Request. The network node 902, in response, sends the UE 904 an RRC Resume message including a request for the report and/or for the one or more parameters. The UE 904 transmits, to the network node 902, the one or more parameters and/or the report in the RRC Resume Complete message.

In another option, the UE 904 is in RRC_INACTIVE. The indication that the one or more parameters and/or a report including the one or more parameters are available can be included in an RRC Resume Complete message sent to the network node 902. The network node 902, in response, sends the UE 904 a UE Information Request message including a request for the report and/or for the one or more parameters. Next, the UE 904 transmits, to network node 902, the one or more parameters and/or the report in the UE Information Response message.

In another option, the UE 904 is in RRC_IDLE. The indication that the one or more parameters and/or a report including the one or more parameters are available can be included in an RRC Setup Complete message. The network node 902, in response, sends the UE 904 a UE Information Request message including a request for the report and/or for the one or more parameters. Next, the UE 904 transmits, to the network node 902, the one or more parameters and/or the report in the UE Information Response message.

In one embodiment, the UE 904 obtains the communication information comprising one or more parameters for ML-model performance monitoring by the network node 902 (e.g., by performing one or more measurements) when it triggers a failure leading to an RRC Reestablishment. Then, when the UE 904 performs the re-establishment procedure, the UE 904 reports these one or more parameters to the network node 902 (e.g., it transmits the report of assistance information for the ML-output performance monitoring by the network node 902).

In one embodiment, the UE 904 transmits an indication to the network node 902 that the communication information comprising the one or more parameters and/or a report including the one or more parameters are available (e.g., stored)). In one option, the indication is included in an RRC Reestablishment Complete message. The network node 902, in response, sends the UE 904 a UE Information Request message including a request for the report and/or for the one or more parameters. Then, the UE 904 transmits, to the network node 902, the one or more parameters and/or the report in the UE Information Response message.

In one option, the indication that the communication information comprising the one or more parameters and/or a report including the one or more parameters are available is included in an RRC Reconfiguration Complete message transmitted by the UE 904 to the network node 902. The network node 902, in response, sends the UE 904 a UE Information Request message including a request for the report and/or for the one or more parameters. Then, the UE 904 transmits, to the network node 902, the one or more parameters and/or the report in the UE Information Response message.

In one embodiment the UE 904 obtains these one or more parameters for ML-model performance monitoring by the network node 902 (e.g., by performing one or more measurements) during a handover procedure. Then, when the UE 904 performs the handover (e.g., random access at the target cell), the UE 904 reports these one or more parameters to the network node 902 (e.g., it transmits the report of assistance information for the ML-output performance monitoring at the network).

In one embodiment, the UE 904 skips the indication to the network node 902 that it has available (e.g., stored) the one or more parameters and/or a report including the one or more parameters. UE 904 may directly report the one or more parameters and/or the report in the RRC Reconfiguration complete message. This can be configured at the handover command by the target.

With continued reference to FIG. 9, in step 960, if the network node 902 has identified that the performance degradation of the UE 904 is due to the second type of error cause (i.e., error cause 2) in Step 950, it means that the performance degradation of UE 904 is likely unrelated to the ML-model itself. The network node 902 may thus configure more reliable transmission schemes for the UE 904 to report its ML-model outputs for a certain period, e.g., until the network nodes 902 detects that the error cause or the performance degradation disappears in an extended time interval (e.g. beyond certain threshold). In one embodiment, the network node 902 may configure a significantly more robust MCS on PUCCH/PUSCH for the ML-based reporting in UCI, monitor the resulting performance, and gradually reduce the resource allocation if no error causes of the second type (e.g., error causes unrelated to the ML model itself) are detected.

In another embodiment, the network node 902 may configure a slightly more robust MCS on PUCCH/PUSCH, monitor the resulting performance, and gradually further increase the resource allocation if error causes of the second type (e.g., error causes unrelate to the ML model itself) persist. Regardless of the error cause identified in Step 950, the network node 902 may also store the information about the events that are related to the error cause. The information can be used to predict the future occurrences of the error, and thereby, triggering a more proactive way of avoiding such errors, e.g., by sending an earlier communication to the UE 904 with a more reliable reporting configuration.

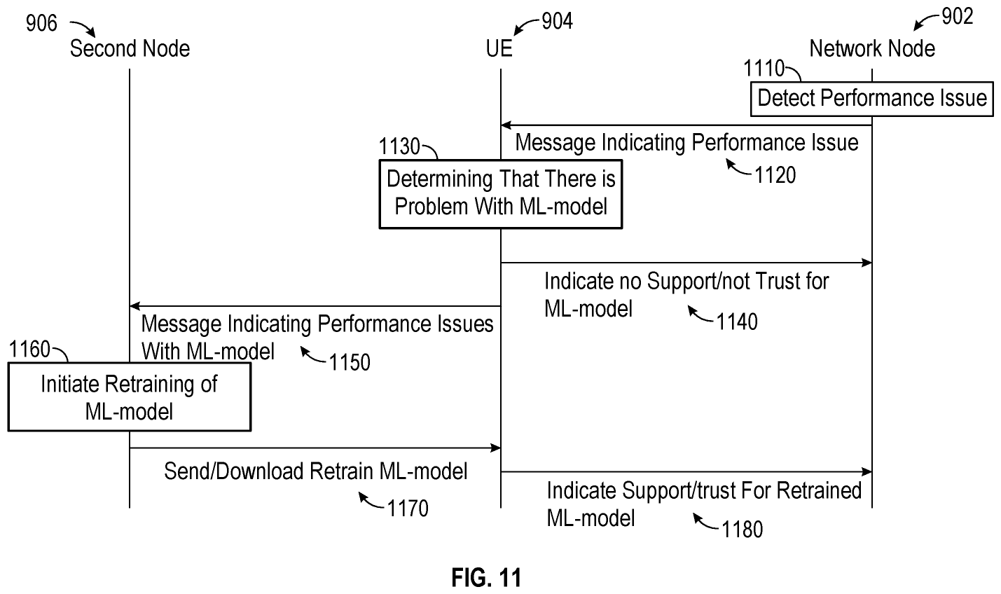

With continued reference to FIG. 9, in step 970, regardless of the error cause identified in Step 950, the network node 902 may send degradation information associated with a cause of degraded performance of the UE 904. FIG. 11 shows a flow chart of communicating between network node 902 and UE 904 about performance issues with the ML-model. When network node 902 detects UE performance issues (step 1110), it sends a message to UE 904 for indicating the degradation information associated with an error cause (e.g., in step 970 or step 1120). The message can be, for example, an RRC message, or an MAC CE or L1 signaling message. The L1 signaling message can have the Downlink Control Information (DCI) format. In one example, the message sent from network node 902 to UE 904 may contain one or more of the following information fields.

In one example, the message may include a representation of ML-model(s) or ML-feature(s) that the message is associated with. The representation can be, for example, in the form of an ID or Identification number that identifies the ML-model(s)/ML-feature(s). In some examples, the message can address one or multiple ML-models at once. In one example, the message may include at least one cell(s) and/or frequency (or frequency band(s)) that are applicable to communication with the UE 904. In one example, the message may include a value in percentage that indicates the confidence level the network node 902 has of the ML-model.

In one example, the message may include a difference in the confidence level related to the output from the ML-model, as reported by the UE 904, from the confidence level experienced by the network node 902. For example, the UE 904 can report a high confidence in a certain prediction, but the network node 902 experiences a large deviation from the UE-reported confidence level in prediction. As a result, the network node 902 can indicate to the UE 904 regarding said confidence level deviation.

In another example, the message may include a confidence interval of the ML-model, where the confidence level can either also be included or, e.g., specified in specification text. In another example, the message may include a value in percentage that indicates the confidence level the network node 902 has of the error cause analysis result(s). In another example, the message may include a confidence interval of the error cause analysis results(s), where the confidence level can either also be included or, e.g., specified in specification text.

In another example, the message may include the statistic information of the data collected within a time window. Optionally, the statistic information can be divided into the data collected per cell or frequency.

In another example, the message may include an indication that model output should or should no longer be trusted (e.g., a single bit indication). This may further be a time series. Thus, the indication may include multiple bits. Each bit may represent a certain time occasion. The time occasion could be a ML-model output sent to the network node 902 or a scheduling occasion from the network node 902. It can further be a specific occasion in time as, for example, symbol(s), slot(s), subframe(s), half-frame(s), frame(s), SFN System Frame number(s), or the like.

In another example, the message may include a throughput loss, a reliability loss, or a latency loss due to an ML-models estimate. This can be, for example, given in percentage or dB compared to the predicted values by the UE 904. It may further be given in some form of absolute numbers.

In another example, the message may include positioning inaccuracy given other methods of positioning the UE 904. In another example, the message may include a time interval for which the message applies to (e.g., the time interval applicable to transmissions of the degraded information). The time interval can be, for example, given in the unit of millisecond (ms), second(s), minutes (min), hour (h), and so on. It may also be given in a unit more specific to the radio system such as symbol(s), slot(s), subframe(s), half-frame(s), frame(s), SFN System Frame number(s), or the like. The time interval may be represented by a start and stop time. It can also be represented by just a start time when message is applicable from. The UE 904 may then infer that this applies at least until the reception of the message. Further, the time interval can also be given by a bitmap wherein each bit, or a set of bits, represents one of the above indications or other indications that the network node 902 may provide to the UE 904.

In another example, the message may include a network configuration corresponding to a time when the ML-model performance of the UE was degraded. This could for example be a part or the full RRC configuration for the UE 904.

With reference to FIGS. 9 and 11, in one embodiment, the network node 902 may inform (steps 970 or 1120) the UE 904 about the degradation information associated with an error cause only when the first type of error cause (e.g., error cause 1) was identified. As described above, the first type of error cause relates to the ML model itself. In a related embodiment, the network node 902 may inform the UE 904 about error cause 2 using a shorter message, including only the error indication and optionally a small subset of the above information items.

With continued reference to FIGS. 9 and 11, after UE 904 receives (steps 970 or 1120) the message from the network node 902, the UE 904 may utilize the information in that message to determine (step 1130) the ML-model(s) that may have performance degradations. In some examples, there may also be a UE-independent check of the ML-model performance based on the information received from the network node 902.

In one embodiment, the network node 902 may reconfigure the UE 904 and disable the usage of the ML-model, e.g., by indicating to the UE 904 that the UE shall not use the ML model. At a later time, the network node 902 may configure the UE 904 to report new instances of the second report. Based on the new instances of the second report (e.g., new communication information including parameters for monitoring the UE performance), network node 902 may verify performance improvements and re-configure the UE 904 to use the ML-model again.

In another embodiment, the UE 904 is configured to perform the monitoring of the performance of the at least one ML-model. The UE 904 may also be configured with an acceptable performance level indicator (e.g., a level of error and threshold indicating an error value, a confidence interface and/or an accuracy value), so that the UE 904 only includes the outputs of the at least one ML-model in a first report and/or second report if the monitored performance is better than the acceptable performance level indicator configured by the network.

In another embodiment, the UE 904 may send the first report to a first network node (e.g., node 902 or a source gNodeB). When the first network node determines to handover the UE 904 to a second network node (e.g., node 906), the first network node includes at least partially the first report (or its content) in, e.g., the Handover Request message. The second network node receives the first report and includes the configuration for the second report in the handover command, which is included in the Handover Request Ack message. The UE 904 receives the handover command, applies the configuration for the second report; and when UE 904 accesses the target cell for the handover (associated to the second network node), it transmits the second report. Based on the first report (or its content), the first network node may determine to disable the ML-model at the UE, wherein that is indicated in the handover command. Thus, upon reception of the handover command, the UE 904 determines to disable the first report when it accesses the target cell.

With reference still to FIGS. 9 and 11, in step 980, regardless of the method utilized to determine that the ML-model has a performance degradation, upon reception of the message specified in Steps 870 or 1120, the UE 904 may perform actions to solve the ML-performance issue. For example, in step 980 of FIG. 9, UE 904 may initiate an ML-model retraining or update. Optionally, UE 904 may first configure a data collection to improve the model performance. As shown in FIGS. 9 and 11, in steps 985 and 1150, if the data collection can be associated to the cell or frequencies where the ML model is underperforming, the UE 904 may further indicate to a second network node 906 that the ML-model cannot be trusted or is no longer supported. In the process shown in FIG. 11, UE 904 may also indicate that the ML model is no longer supported or trusted to network node 902. For instance, the UE 904 may further indicate to a second network node 906 that the ML-model(s) performance was not sufficient in accordance with the message from the network node 902. Such message may also include additional information such as the operator identifier, position(s), band(s), or the like. Subsequently, in step 990 of FIG. 9 or step 1160 of FIG. 11, the second node 906 may start a process of retraining the relevant ML-model(s) or may decide to transmit a different ML-model to the UE 904. The second node 906 may be a server node configured to collect training data and retrain the ML model. After this retraining is done, the UE 904 may retrieve/be pushed/download (step 995 in FIG. 9 or step 1170 of FIG. 11) the relevant ML-model(s), after which the UE 904 can again indicate support (in step 1180 of FIG. 11) for the ML-model(s)/ML-feature(s). In one embodiment, the second node 906 may be a node outside the network and the contact with it may be performed using over-the-top (OTT) signaling.

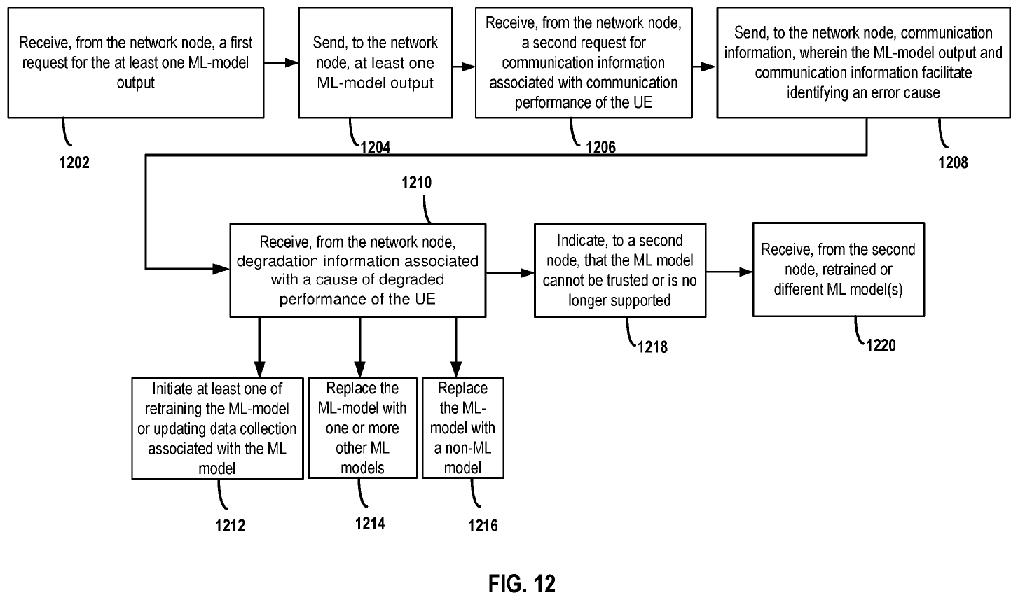

FIG. 12 is a flowchart illustrating a method 1200 performed by a UE (e.g., UE 904) in accordance with some embodiments. In step 1202, the UE receives, from the network node, a first request for the at least one ML-model output. The first request may include a first reporting configuration. Step 1202 corresponds to step 900 described above. In some examples, the first request is received in a radio resource control (RRC) message corresponding to at least one of the following: an RRC RESUME message used when the UE transits from RRC_INACTIVE to RRC_CONNECTED, an RRC Setup message when the UE transits from RRC_IDLE to RRC_CONNECTED, or an RRC Reconfiguration message when the UE is in RRC_CONNECTED. In some examples, the first request is received with an Information Element (IE) or field including one or more parameters for at least one of channel state information (CSI) reporting or beam management reporting. In some examples, the first request is received in a medium access control (MAC)-control element (CE) or a downlink control information (DCI) message.

Next, in step 1204, the UE sends, to the network node, at least one ML-model output. Step 1204 corresponds to step 910 described above. The ML-model output(s) may be included in a first report. Then in step 1206, the UE receives from the network node a second request for communication information associated with communication performance of the UE. The second request may include a second reporting configuration. Step 1206 corresponds to step 930 described above. In some examples, at least one of the first request or the second request is received in a periodic, aperiodic, semi-persistent, or event-triggered manner. In some examples, the second request is received with the first request. For example, the two requests may be combined.

In step 1208, the UE sends, to the network node, communication information. Step 1208 corresponds to step 940 described above. The communication information is associated with communication performance of the UE and can be included in a second report. The communication information may be sent after the UE transits to RRC_CONNECTED from RRC_IDLE or RRC_INACTIVE, wherein the communication information comprises measurements collected when the UE is in RRC_IDLE or RRC_INACTIVE. In some examples, the UE is configured to send the at least one ML-model output and the communication information in one report, thus combining the first report and the second report.

In some examples, the communication information associated with communication performance of the UE comprises at least one of the following: radio measurements with different types comparing to the at least one ML-model output, reference signals, multiplexed uplink data with one or more ML-model outputs, and one or more ML-model outputs configured with different transmission parameters compared to the at least one ML-model output.

In some examples, the at least one ML-model output (in the first report) and the communication information (in the second report) associated with communication performance of the UE facilitate determination of a cause of degraded performance of the UE including at least one of a cause related to the ML model or a cause unrelated to the ML model.

In step 1210, the UE receives, from the network node, degradation information associated with the cause of degraded performance of the UE. Step 1210 corresponds to step 970 described above. The degradation information indicates whether the cause of performance degradation is due to error cause 1 or error cause 2.

Based on the degradation information indicating the error cause, the UE can perform one or more of steps 1212, 1214, 1216, 1218, and 1220. In step 1212 (corresponding to step 980 described above), the UE initiates at least one of retraining the ML-model or updating data collection associated with the ML model. In step 1214, the UE replaces the ML-model with one or more other ML models. In step 1216, the UE replaces the ML-model with a non-ML model. In step 1218 (corresponding to step 985 described above), the UE indicates to a second node that the ML model cannot be trusted or is no longer supported. In step 1220 (corresponding to step 995 described above), the UE receives, from the second node, retrained or different ML model(s).

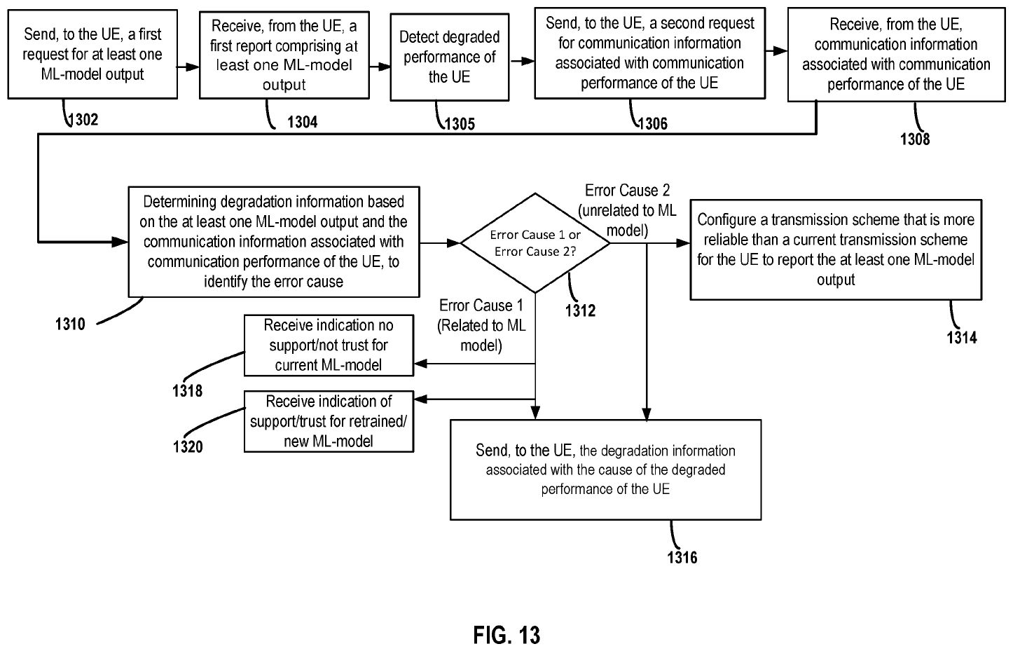

FIG. 13 is a flowchart illustrating a method 1300 performed by a network node (e.g., node 902) in accordance with some embodiments. In step 1302, the network node sends the UE a first request for at least one ML-model output. The first request may include a first report configuration. Step 1302 corresponds to step 900 described above.

In step 1304, the network node receives, from the UE, at least one ML-model output. The model output may be included in a first report. Step 1304 corresponds to step 910 described above.

In step 1305, the network node detects degraded performance of the UE. Step 1305 corresponds to step 920 described above. Detecting the degraded performance of the UE can be based on one or more of: the UE's previous performance; an average performance of one or more other UEs; estimated performance or estimated report contents based on UE modeling in the network node; an uncertainty indication signaled from the UE; and a reliability indication signaled from the UE. In one example, detecting the degraded performance of the UE based on the UE's previous performance comprises detecting a change or inconsistency compared to the UE's previous reports.

In step 1306, the network node sends the UE a second request for communication information associated with communication performance of the UE. The second request may include a second reporting configuration for the communication information. Step 1306 corresponds to step 930 described above. In some examples, the second request is sent when the network node detects degraded performance of the UE based on the at least one ML-model output. In some examples, the second report configuration is applicable to at least one of the following: a future parameter measurement and reporting occasion; a current parameter measurement and a future performance degradation occasion for the ML-mode of the UE, where the communication information comprises a future ML-based estimate and additional data pertaining to the current performance degradation occasion; or an additional performance degradation occasion, where the communication information contains additional data pertaining to the current performance degradation occasion.

In step 1308, the network node receives, from the UE, communication information associated with communication performance of the UE. Step 1308 corresponds to step 940 described above. The communication information may be included in a second report, and used for assisting the network node to identify an error cause of the UE's performance degradation.

In step 1310, the network node determines degradation information based on the at least one ML-model output and the communication information associated with communication performance of the UE. Step 1310 corresponds to step 950 described above. The degradation information is determined by performing one or more of the following: comparing the at least one ML-model output with the communication information; comparing the at least one ML-model output and other information provided in the communication information; evaluating link conditions based on the other information provided in the communication information; and analyzing an uplink control information (UCI) false detection probability, based on a cyclic redundancy check (CRC) length for a first report payload.

In step 1312, the network node determines if the error cause identified is error cause 1 (related to ML model) or error cause 2 (unrelated to ML model). Step 1312 corresponds to step 950 described above.

In step 1316, regardless of the type of error cause, the network node sends, to the UE, degradation information associated with a cause of degraded performance of the UE. The cause of the degraded performance of the UE includes at least one of a cause related to the ML-model or a cause unrelated to the ML model. Step 1316 corresponds to step 970 described above. In some examples, the degradation information associated with the cause of the degraded performance of the UE is sent with one or more of: at least one of a representation of the at least one ML-model or ML-model features that the degradation information is associated with; at least one cell or frequency applicable to communication with the UE; an indication that model outputs should be trusted or should no longer be trusted; at least one of a throughput loss, a reliability loss, or a latency loss due to an estimate of the at least one ML-model; positioning inaccuracy based on UE positioning methods that do not use the ML-model; a time interval applicable to transmissions of the degradation information; and a network configuration corresponding to a time when the ML-model performance of the UE was degraded. In some examples, the degradation information is sent with one or more of: a value in percentage that indicates a confidence level that the network node 902 has of the ML-model; a difference in a confidence related to the at least one ML-model output sent by the UE; a confidence interval of the ML-model; a value in percentage that indicates a confidence level of results associated with analyzing the cause of degraded performance of the UE; a confidence interval of error cause analysis results; and statistical information of data collected within a time window. In some examples, the degradation information associated with the cause of the degraded performance of the UE is sent via a radio resource control (RRC) message, a medium access control (MAC)-control element (CE) message or a downlink control information (DCI) message.

In step 1314, if the network node determines that the error cause is unrelated to the ML model (e.g., error cause 2), the network node configures a transmission scheme that is more reliable than a current transmission scheme for the UE to report the at least one ML-model output in accordance with a network node's determination that the cause of degraded performance of the UE is an erroneous reception communication performed by the UE. Step 1314 corresponds to step 960 described above. In some examples, the network node further stores events that are related to the degraded performance of the UE after the network node determines the cause of degraded performance of the UE.

If the network node determines that the error cause is related to the ML model (e.g., error cause 1), one or more of steps 1318 and 1320 may be performed. In step 1318, the network node receives an indication from the UE that current ML model is no longer supported or trusted. Step 1318 corresponds to step 1140 described above. In step 1320, the network node receives an indication from the UE that the retrained ML model or different ML model is supported and trusted. Step 1320 corresponds to step 1180 described above.

### EMBODIMENTS

### Group A Embodiments

1. A method performed by a user equipment (UE) for error detection for machine learning (ML)-model performance of the UE, the method comprising:
   transmitting, to a network node, at least one ML-model output; and
   transmitting, to the network node, first information associated with communication performance of the UE.
2. The method of embodiment 1, further comprising the step of:
   receiving, from the network node, second information associated with a cause of erroneous performance of the UE.
3. The method of embodiment 1, wherein the at least one ML-model output is transmitted upon a first request from the network node.
4. The method of embodiment 2, wherein the first request from the network node is transmitted in a RRC message corresponding to at least one of the following: an RRC RESUME message used for a UE transitioning from RRC_INACTIVE to RRC_CONNECTED, an RRC Setup message used for a UE transitioning from RRC_IDLE to RRC_CONNECTED, or an RRC Reconfiguration message used for a UE in RRC_CONNECTED.
5. The method of embodiment 2, wherein the first request from the network node is transmitted with an Information Element (IE) or field including one or more parameters for channel state information (CSI) reporting and/or beam management reporting.
6. The method of embodiment 1, wherein the first information associated with communication performance of the UE is transmitted upon a second request from the network node.
7. The method of embodiment 5, wherein the transmission of the first request or the second request is one of the following types: periodic, aperiodic, semi-persistent or event-triggered.
8. The method of embodiment 6, wherein the second request is transmitted with the first request.
9. The method of embodiment 1, wherein the first information associated with communication performance of the UE comprises at least one of the following: parameter measurements, reference signals, multiplexed uplink data, and/or the ML-model output.
10. The method of the embodiment 1, further comprising the step of:
   executing actions to solve the ML-performance issue after receiving, from the network node, the information associated with the cause of erroneous performance of the UE.
11. The method of the embodiment 9, wherein executing actions to solve the ML-performance issue comprises:
   initiating ML-model retraining/update; or
   falling back to a legacy ML-model.
12. The method of the embodiment 9, wherein executing actions to solve the ML-performance issue comprises:
   indicating to a second node that the ML-model cannot be trusted or is no longer supported.
13. The method of any of the previous embodiments, further comprising:
   providing user data; and
   forwarding the user data to a host via the transmission to the network node.

### Group B Embodiments

14. A method performed by a network node for error detection for machine learning (ML)-model performance of a user equipment (UE), the method comprising:
   receiving, from the UE, at least one ML-model output;
   receiving, from the UE, first information associated with communication performance of the UE;
   determining, based on the at least one ML-model output and the first information associated with communication performance of the UE, second information associated with a cause of erroneous performance of the UE; and
   transmitting, to the UE, the information associated with the cause of the erroneous performance of the UE.
15. The method of embodiment 14, further comprising the step of: detecting erroneous performance of the UE by observing one or more of the following.:
   performance degradation compared to the UE's previous performance;
   performance degradation of the UE compared to average performance of other UE in the same cell or cell region;
   deviation or inconsistency compared to estimated performance or estimated report contents based on UE modeling in a gNodeB (gNB);
   a high uncertainty indication signaled from the UE; and
   a low reliability indication signaled from the UE.
16. The method of embodiment 15, further comprising the step of:
   transmitting, to the UE, a request for the first information when the network node detects erroneous performance of the UE through the at least one ML-model output.
17. The method of embodiment 14 wherein performance degradation compared to the UE's previous performance is based on sudden change or inconsistency compared to the same UE's previous reports.
18. The method of embodiment 14 wherein performance degradation of the UE compared to average performance of other UE in the same cell or cell region is based on deviation or inconsistency compared to other UE reports in the same cell or cell region.
19. The method of embodiment 14, wherein the first information associated with communication performance of the UE is at least one of the following:
   applied to a future measurement and reporting occasion;
   applied to the current measurement and a future reporting occasion, where the report contains a future ML-based estimate and additional data pertaining to the current occasion; and/or
   applied to an additional reporting occasion, where the report contains additional data pertaining to the current occasion.
20. The method of embodiment 14, wherein determining, based on the at least one ML-model output and the first information associated with communication performance of the UE, information associated with cause of erroneous performance of the UE comprises one or more of:
   comparing ML report contents in the first and second reports;
   comparing ML report contents and additional information provided in the second report;
   evaluating link conditions based on the additional info in the second report; and
   considering the uplink control information (UCI) false detection probability, based on the cyclic redundancy check (CRC) length for the first report payload.
21. The method of embodiment 14, further comprising the step of: configuring more reliable transmission schemes for the UE to report its ML-model output for a certain period if the network nodes determines that the cause of erroneous performance of the UE is an erroneous reception communication performed by the UE.
22. The method of embodiment 14, further comprising the step of: storing the information about the events that are related to the erroneous performance of the UE after the network node determines the cause of erroneous performance of the UE.
23. The method of embodiment 15, wherein the information associated with the cause of the erroneous performance of the UE comprises one or more of: ML-model(s)/ML-feature(s) that the message is associated with;
   a value in percentage that indicates the confidence level the network has of the ML-model;
   a difference in the confidence related to the output from the ML-model, reported by the UE;
   a confidence interval of the ML-model;
   a value in percentage that indicates the confidence level the network has of the error cause analysis result(s);
   a confidence interval of the error cause analysis results(s);
   the statistical information of the data collected within a time window;
   indication that model output should or should no longer be trusted;
   throughput loss, reliability or latency loss due to ML-models estimate;
   positioning inaccuracy given other methods of positioning the UE;
   time interval for which the message applies to; and
   the network configuration for when the ML-model performance was not sufficient.
24. The method of any of the previous embodiments, further comprising:
   obtaining user data; and
   forwarding the user data to a host or a user equipment.

### Group C Embodiments

25. A user equipment (UE) for error detection for machine learning (ML)-model performance of the UE, comprising:
   processing circuitry configured to perform any of the steps of any of the Group A embodiments; and
   power supply circuitry configured to supply power to the processing circuitry.
26. A network node for error detection for machine learning (ML)-model performance of a UE, the network node comprising:
   processing circuitry configured to perform any of the steps of any of the Group B embodiments;
   power supply circuitry configured to supply power to the processing circuitry.
27. A user equipment (UE) for error detection for machine learning (ML)-model performance of the UE, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
28. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to receive the user data from the host.
29. The host of the previous embodiment, wherein the cellular network further includes a network node configured to communicate with the UE to transmit the user data to the UE from the host.
30. The host of the previous 2 embodiments, wherein:
   the processing circuitry of the host is configured to execute a host application, thereby providing the user data; and
   the host application is configured to interact with a client application executing on the UE, the client application being associated with the host application.
31. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
32. The method of the previous embodiment, further comprising: at the host, executing a host application associated with a client application executing on the UE to receive the user data from the UE.
33. The method of the previous embodiment, further comprising: at the host, transmitting input data to the client application executing on the UE, the input data being provided by executing the host application, wherein the user data is provided by the client application in response to the input data from the host application.
34. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to transmit the user data to the host.
35. The host of the previous embodiment, wherein the cellular network further includes a network node configured to communicate with the UE to transmit the user data from the UE to the host.
36. The host of either of the previous two embodiments, wherein:
   the processing circuitry of the host is configured to execute a host application, thereby providing the user data; and
   the host application is configured to interact with a client application executing on the UE, the client application being associated with the host application.
37. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
38. The method of the previous embodiment, further comprising:
   at the host, executing a host application associated with a client application executing on the UE to receive the user data from the UE.
39. The method of the previous embodiment, further comprising:
   at the host, transmitting input data to the client application executing on the UE, the input data being provided by executing the host application, wherein the user data is provided by the client application in response to the input data from the host application.
40. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
41. The host of the previous embodiment, wherein:
   the processing circuitry of the host is configured to execute a host application that provides the user data; and
   the UE comprises processing circuitry configured to execute a client application associated with the host application to receive the transmission of user data from the host.
42. A method implemented in a host configured to operate in a communication system that further includes a network node and a user equipment (UE), the method comprising: providing user data for the UE; and
   initiating a transmission carrying the user data to the UE via a cellular network comprising the network node, wherein the network node performs any of the operations of any of the Group B embodiments to transmit the user data from the host to the UE.
43. The method of the previous embodiment, further comprising, at the network node, transmitting the user data provided by the host for the UE.
44. The method of any of the previous 2 embodiments, wherein the user data is provided at the host by executing a host application that interacts with a client application executing on the UE, the client application being associated with the host application.
45. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
46. The communication system of the previous embodiment, further comprising:
   the network node; and/or
   the user equipment.
47. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
48. The host of the previous 2 embodiments, wherein:
   the processing circuitry of the host is configured to execute a host application, thereby providing the user data; and
   the host application is configured to interact with a client application executing on the UE, the client application being associated with the host application.
49. The host of the any of the previous 2 embodiments, wherein the initiating receipt of the user data comprises requesting the user data.
50. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
51. The method of the previous embodiment, further comprising at the network node, transmitting the received user data to the host.

Although the computing devices described herein (e.g., UEs, network node 902s, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node 902, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The foregoing specification is to be understood as being in every respect illustrative and exemplary, but not restrictive, and the scope of the disclosure herein is not to be determined from the specification, but rather from the claims as interpreted according to the full breadth permitted by the patent laws. It is to be understood that the embodiments shown and described herein are only illustrative of the principles of the present disclosure and that various modifications may be implemented by those skilled in the art without departing from the scope and spirit of the present disclosure. Those skilled in the art could implement various other feature combinations without departing from the scope and spirit of the disclosure.

1. A method performed by a user equipment (UE) for detecting performance degradation of a machine learning (ML)-model utilizable by the UE, the method comprising:
sending, to a network node, at least one ML-model output; and
sending, to the network node, communication information, wherein the communication information is associated with communication performance of the UE with respect to the utilization of the ML model by the UE.

2. The method of claim 1, wherein the at least one ML-model output and the communication information associated with communication performance of the UE facilitate performance assessment of an ML-model operable by the UE.

3. The method of claim 1, further comprising: receiving, from the network node, degradation information associated with a cause of degraded performance of the UE including at least one of a cause related to the ML model or a cause unrelated to the ML model.

4. The method of claim 1, wherein the UE is configured to send the at least one ML-model output and the communication information in one report.

5. The method of claim 1, wherein the communication information is sent after the UE transits to RRC_CONNECTED from RRC_IDLE or RRC_INACTIVE, wherein the communication information comprises measurements collected when the UE is in RRC_IDLE or RRC_INACTIVE.

6. The method of claim 1, further comprising: receiving, from the network node, a first request for the at least one ML-model output.

7. The method of claim 6, wherein the first request is received in a radio resource control (RRC) message corresponding to at least one of the following: an RRC RESUME message used when the UE transits from RRC_INACTIVE to RRC_CONNECTED, an RRC Setup message when the UE transits from RRC_IDLE to RRC_CONNECTED, or an RRC Reconfiguration message when the UE is in RRC_CONNECTED.

8. The method of claim 6, wherein the first request is received with an Information Element (IE) or field including one or more parameters for at least one of channel state information (CSI) reporting or beam management reporting.

9. The method of claim 6, wherein the first request is received in a medium access control (MAC)-control element (CE) or a downlink control information (DCI) message.

10. The method of claim 6, further comprising: receiving, from the network node, a second request for the communication information.

11. The method of claim 10, wherein at least one of the first request or the second request is received in a periodic, aperiodic, semi-persistent, or event-triggered manner.

12. The method of claim 10, wherein the second request is received with the first request.

13. The method claim 1, wherein the communication information associated with communication performance of the UE comprises at least one of the following: radio measurements with different types comparing to the at least one ML-model output, reference signals, multiplexed uplink data with one or more ML-model outputs, and one or more ML-model outputs configured with different transmission parameters compared to the at least one ML-model output.

14-15. (canceled)

16. A method performed by a network node for detecting performance degradation for machine learning (ML)-model performance of a user equipment (UE), the method comprising:
receiving, from the UE, at least one ML-model output;
receiving, from the UE, communication information associated with communication performance of the UE; and
sending, to the UE, degradation information associated with a cause of degraded performance of the UE, the cause of the degraded performance of the UE including at least one of a cause related to the ML-model or a cause unrelated to the ML model, wherein the degradation information is determined based on the at least one ML-model output and the communication information associated with communication performance of the UE.

17. The method of claim 16, further comprising:
detecting the degraded performance of the UE based on one or more of:
the UE's previous performance;
an average performance of one or more other UEs;
estimated performance or estimated report contents based on UE modeling in the network node;
an uncertainty indication signaled from the UE; and
a reliability indication signaled from the UE.

18. The method of claim 17, wherein detecting the degraded performance of the UE based on the UE's previous performance comprises detecting a change or inconsistency compared to the UE's previous reports.

19. The method of claim 16, further comprising:
sending, to the UE, a request for the communication information.

20. The method of claim 19, wherein the request is sent when the network node detects degraded performance of the UE based on the at least one ML-model output.

21. The method of claim 19, wherein a configuration of the communication information is applicable to at least one of the following:
a future parameter measurement and reporting occasion;
a current parameter measurement and a future performance degradation occasion for the ML-mode of the UE, where the communication information comprises a future ML-based estimate and additional data pertaining to the current performance degradation occasion; or
an additional performance degradation occasion, where the communication information contains additional data pertaining to the current performance degradation occasion.

22. The method of claim 16, wherein the degradation information is determined by performing one or more of the following:
comparing the at least one ML-model output with the communication information;
comparing the at least one ML-model output and other information provided in the communication information;
evaluating link conditions based on the other information provided in the communication information; and
analyzing an uplink control information (UCI) false detection probability, based on a cyclic redundancy check (CRC) length for a first report payload.

23. The method of claim 16, further comprising:
configuring a transmission scheme that is more reliable than a current transmission scheme for the UE to report the at least one ML-model output in accordance with a network node's determination that the cause of degraded performance of the UE is an erroneous reception communication performed by the UE.

24-27. (canceled)

28. A network node for performing user equipment (UE) machine-learning (ML) model analysis, the network node comprising:
a transceiver, a processor, and a memory, said memory containing instructions executable by the processor whereby the network node is operative to perform:
receiving, from the UE, at least one ML-model output;
receiving, from the UE, communication information associated with communication performance of the UE; and
sending, to the UE, degradation information associated with a cause of degraded performance of the UE, the cause of the degraded performance of the UE including at least one of a cause related to the ML-model or a cause unrelated to the ML model, wherein the degradation information is determined based on the at least one ML-model output and the communication information associated with communication performance of the UE.

29-39. (canceled)

40. A user equipment (UE) for performing user equipment (UE) machine-learning (ML) model analysis, the UE comprising:
a transceiver, a processor, and a memory, said memory containing instructions executable by the processor whereby the UE is operative to perform:
sending, to a network node, at least one ML-model output; and
sending, to the network node, communication information, wherein the communication information is associated with communication performance of the UE,
wherein the at least one ML-model output and the communication information associated with communication performance of the UE facilitate determination of a cause of degraded performance of the UE including at least one of a cause related to the ML model or a cause unrelated to the ML model.

41-53. (canceled)
